(19) United States
(12) Patent Application Publication
(10) Pub. No.: US 2006/0102795 A1
(43) Pub. Date: May 18, 2006

(54) Fusion energy system and plasma propulsion aircraft to produce electricity from a controlled nuclear fusion reaction

(76) Inventor: Gary Richard Gochnour, Seattle, WA (US)

Correspondence Address: Gary Richard Gochnour, Apt #303, 1415 E. Olive Street, Seattle, WA, 98122, US

(21) Appl. No.: 11/137,643

(22) Filed: May 25, 2005

Related U.S. Application Data
(63) Continuation-in-part of application No. 10/841,702, filed on May 6, 2004.
(60) Provisional application No. 60/468,598, filed on May 6, 2003.

(51) Int. Cl. B64G 1/40

(52) U.S. Cl. 244/171.5

(57) ABSTRACT

The invention relates to plasma based aircraft maintained in a flight-mode by an uplifting Larmor gyro orbiting particle field, and an extensive capacitor system. Said aircraft is comprised of chromium steel, or higher ferrochromium steel can also be used. Said aircraft system can operate utilizing only energy required to initiate operation of said craft. The energy to start said craft is from energy stored within said capacitor system, and said energy also obtained from the operating environment. Said craft, is immediately capable of space flight, use as a submersible craft, or use as an energy source in an artificial environment. Said craft is opaque, invisible within the visible spectrum, invisible to electromagnetic radiation, and absorbs radiation it produces. Said aircraft is capable of soundless flight. Said aircraft is capable of verticle ascent, descent and landing. Said aircraft can operate within earth radiation belts. Said aircraft is capable of speeds in excess of the fastest aerodynamic aircraft, said aircraft navigates within a particle field at a faster rate than conventional aerodyamic aircraft within the atmosphere. Said aircraft, with two larger, faster aircraft, comprised of magnesium aluminum material, can attain ignition of a formed fusion spherical plasma on roof of said ferromagnetic, smaller craft, utilizing the fuels boron B-11 isotope and regular hydrogen with no radiation, cooling needed.

### CROSS-REFERENCE TO RELATED APPlICATIONS

This application is a continuation in part of Ser. No. 10/841702, filed 2004, May 6, by present inventor, now abandoned, which claims the priority to provisional patent application with Ser. No. 60/468,598, filed 2003, May 6, by the present inventor.

### BACKGROUND OF THE INVENTION

### Field of Invention

This invention relates to a new type multi-functional electro-magnetic, plasma based aircraft, capable of operation in the atmosphere as an aircraft, underwater as a submersible craft, in outer space as a space craft, or as a boring device, or a lifting device. Three of the aircraft described, utilized in an aircraft mode, being craft of variable sizes, utilized together, are able to be used in a process with resultant nuclear fusion reaction to obtain electricity. The fusion process will be explained in detail in a process portion of this utility patent. Negligible radiation will be produced, only charged particles.

### OBJECTS AND ADVANTAGES

This invention will make possible travel in space at small cost. Depletion of the world's resources will no longer be a problem. This invention is on a par with the discovery of fire, insofar as man's future is concerned.

### SUMMARY OF THE INVENTION

In the present invention, an aircraft operates within a plasma environment of charged particles. The aircraft operations will be performed in a hyperdynamic state. The fusion energy portion of this utility patent, utilizes the aircraft in fusion process.

In the aircraft of present invention, ions will be produced by the aircraft.

In the present invention, ions will be placed into Larmor gyro orbiting particle fields around the aircraft.

In the present invention, an orbiting particle field, possessing a rotational direction for upward motional movement, will lift the aircraft off the ground or other surface.

In the present invention, navigation will be by means of utilizing ailerons possessing a charge within the particle fields, and by use of rotating plasma vortices placing aircraft in direction of travel by means of ailerons.

In the present invention, only energy from capacitors sufficent to begin operation, will be required for operation of aircraft.

In the present invention, the aircraft will produce operational energy for aircraft from the plasma fields.

In the present invention, the aircraft with two or more larger similar aircraft can produce electricity, from a fusion process.

In this invention, the aircraft can be used as an aircraft, a spacecraft, submersible craft, boring or lifting device.

### BRIEF DESCRIPTION OF THE DRAWINGS

FIG. 1 is a side view of the aircraft showing lenticular configuration of aircraft, and a side view of the annular bladed ring assembly encircling the aircraft, and extending out from the sides of aircraft.

FIG. 2 is a top plan view of the aircraft showing the circular configuration of aircraft, and a top plan view showing the annular bladed ring assembly.

FIG. 3 is a bottom plan view showing the circular configuratin of aircraft, and a bottom plan view showing the annular bladed ring assembly.

FIG. 4 is a top plan view of capacitor, electric system attached to top of top planar surface showing bottom half of aircraft hull, and a top plan view showing the annular bladed ring assembly.

FIG. 5 is a cross section side view of the aircraft showing an ion acceleration system and the central shaft containing an induction coil. Also shown is a cross section side view of the annular bladed ring, capacitor system, and electrolysis system.

FIG. 6A is a diagram showing the space between the upper and lower hulls for attachment of ailerons to multi-bladed annular ring.

FIG. 6B is a side view of the opening between the aircraft hulls to extract worn or burnt ailerons, or to attach replacement ailerons.

FIG. 6C is a side view of the aircraft using particle impact on ailerons to determine banking direction.

FIG. 6D is a side view of the aircraft using particle impact on ailerons to determine banking direction.

FIG. 6E is a side view of the aircraft. The charged particles are impacting ailerons on bottom surface. The aircraft will rise in altitude.

FIG. 6F is a side view of the aircraft using particle impact on ailerons to determine altitude direction. Particles will impact top surfaces of ailerons. The aircraft will descend.

FIG. 7A is a side view of an aircraft within rotating vortices. Ailerons have determined the position for direction of travel. Increase in rotation of vortices will propel the aircraft diagonal to Earth.

FIG. 7B is a side view of an aircraft within rotating vortices being propelled horizontal with Earth.

FIG. 7C is a side view of an aircraft within rotating vortices.

Increase in rotation of vortices will propel the aircraft vertical to Earth.

FIG. 8A is a top view of extricated capacitor system from aircraft, combined negative charge is moving aircraft away from lesser positive charge in direction of arrow.

FIG. 8B is a top view of extricated capacitor system from aircraft. Combined positive charge greater than negative is moving craft away from negative charge in direction of arrow.

FIG. 9 is a top view of the aircraft plasma propulsion system with capacitor, electric system and radial plasma gun.

FIG. 10 is a side view of aircraft in electric force propulsion mode interacting with Earth's magnetic field.

FIG. 11A is a perspective view of the top surface of aircraft showing exit electrodes for fusion fuels and propulsion fuels. FIG. 11B is a side view of aircraft showing raised pyramid and ion acceleration system, and ball electrode.

FIG. 12A is a side view of three aircraft positioned to effect a nuclear fusion reaction.

FIG. 12B is a side view of the fusion spherical plasma and two adjacent spherical plasmas showing directions of plasma rotation.

FIG. 12C is a top view of the induced Larmor orbiting particle field and a top view of the spherical plasma for ignition.

FIG. 12D is a top plan view of the array of barrel shaped devices and electrodes for electrolysis.

FIG. 12E is a perspective view from the side of a cutaway view of an array of containment barrels and an electrolysis system.

FIG. 13 is a side view of three aircraft positioned to effect a nuclear fusion reaction close to ignition of spherical plasma.

FIG. 14 is a spherical plasma between the three aircraft in the process of ignition by land based laser and neutral beam.

FIG. 15, shows end phase of fusion process, storing electricity.

### DESCRIPTION OF THE PREFERRED EMBODIMENT

The operation of aircraft as a system and device will be described first. Said aircraft being the central device. This will be followed by a description of the preferred embodiment pertaining to aircraft. Next a process portion of this utility patent will describe a process producing funnel shaped spirals of particles. Next a process portion of this patent will describe a fusion energy process utilizing aircraft. Said processes will be described first, followed by descriptions relating to the preferred embodiments for said processes. Reference numbers where required are furnished following a brief literary exposition describing aircraft. Craft is comprised of the material chromium steel. When starting operation, the remnant magnetism of the ferromagnetic hull of said craft, will be charged from an array of capacitors connected in parallel within an oscillatory circuit containing inductance. Said starting charge establishes a magnetic field around said craft. At the same time, said capacitor system will provide a weak current through uninsulated field windings around blades within an array of 32 blades encircling said aircraft. Said uninsulated tungsten wire, preferred embodiment, will produce an abundance of free ions on said uninsulated wire surfaces.

Ions will be, freed with current from capacitors through wires by the uninsulated field windings, and upon being energized by field windings, will depart said annular ring of blades at a voltage recognized to energize ions. Said ions will depart said array of blades energized charged particles, and as the craft has a developed magnetic field, said ions will be warped into Larmor gyro orbits around said aircraft. The more energetic particlies, electrons, will ascend to the apices of said Larmor plasma particle fields, forming funnel shaped vortices on the top and bottom surfaces of said annular bladed ring assembly.

Said ions will be affected by a Lorentz force at right angles to the magnetic and electric fields of said aircraft. The narrowing orbits of the more energetic particles will also affect general shape of said plasma vortices.

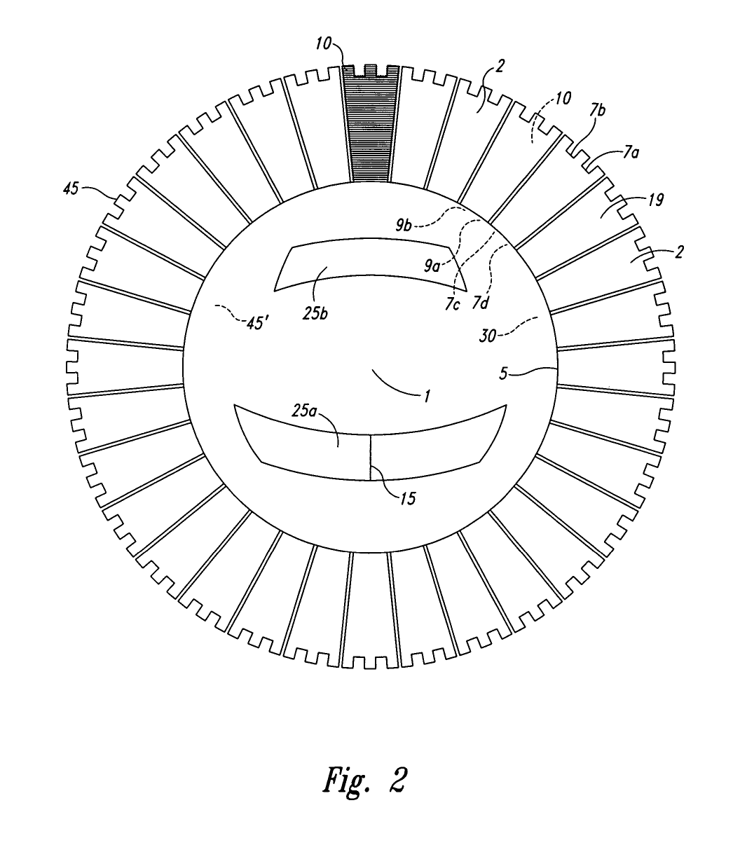

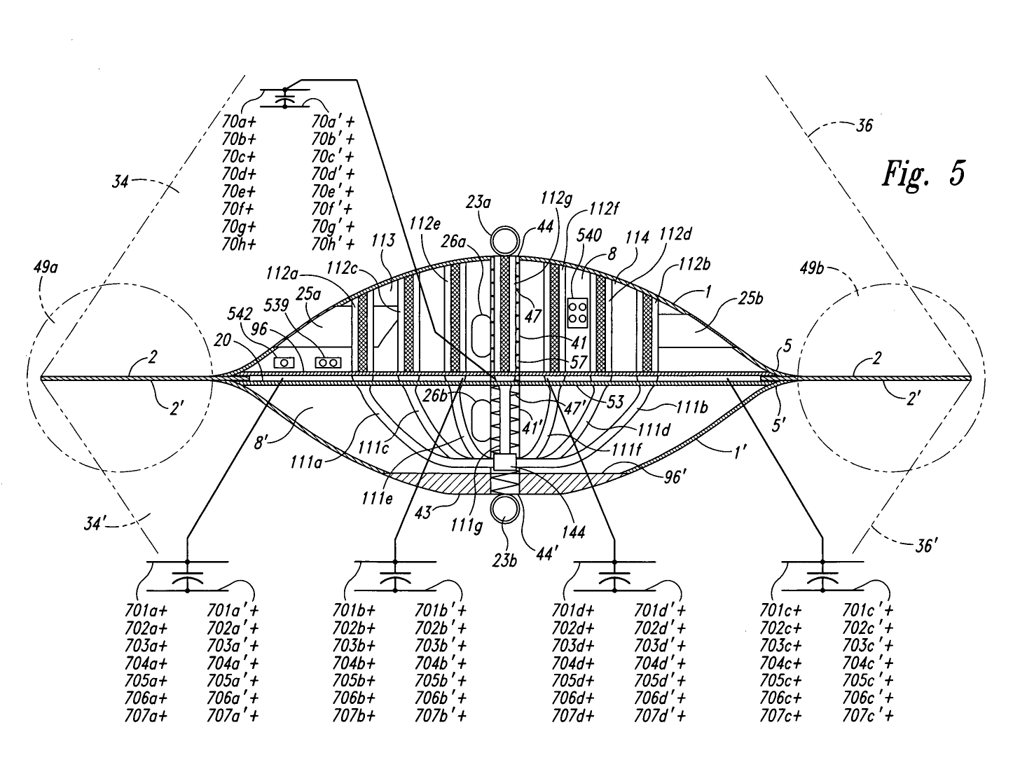

The Larmor gyro orbiting particle field, a plasma field, a diamagnetic, moving magnetic field, passing over the top and bottom surfaces of said conducting field windings 20, FIG. 2, on fixed array of blades 2, FIGS. 2 and 5, generates electricity. The moving magnetic field is the rotor, the field windings are the fixed stator armature. This is a new form of electric generator. Said strong current exiting will be stored within said capacitance inductance system. Said aircraft possesses an oscillatory circuit. Usually an oscillatory circuit loses energy as it emits some, or all energy as electromagnetic radiation. Within this system, the overarching plasma vortices will reabsorb this emitted radiation, perhaps through the Debye effect. The area under said vortices is also a vacuum area. This cyclic increase in energy will continue until the large wave form of plasma is reached, at which time it will be self perpetuating, not requiring additonal energy. As conceived, said aircraft does not require fuel to be provided for aircraft to operate. Energy is nondepleting from environment.

Fuel for said aircraft is stored starting energy. In the event of depletion of said stored energy, energy can be obtained from an on-board electrolysis system. Said system utilizes ferromagnetic cored columns with rotating remnant ions circling said fertomagnetic columns within craft. Said system will initiate production of ions from water with on-board electrodes, until capacitor system is again storing energy. The same ions will be simultaneously, circling, charging said ferromagnetic hull.

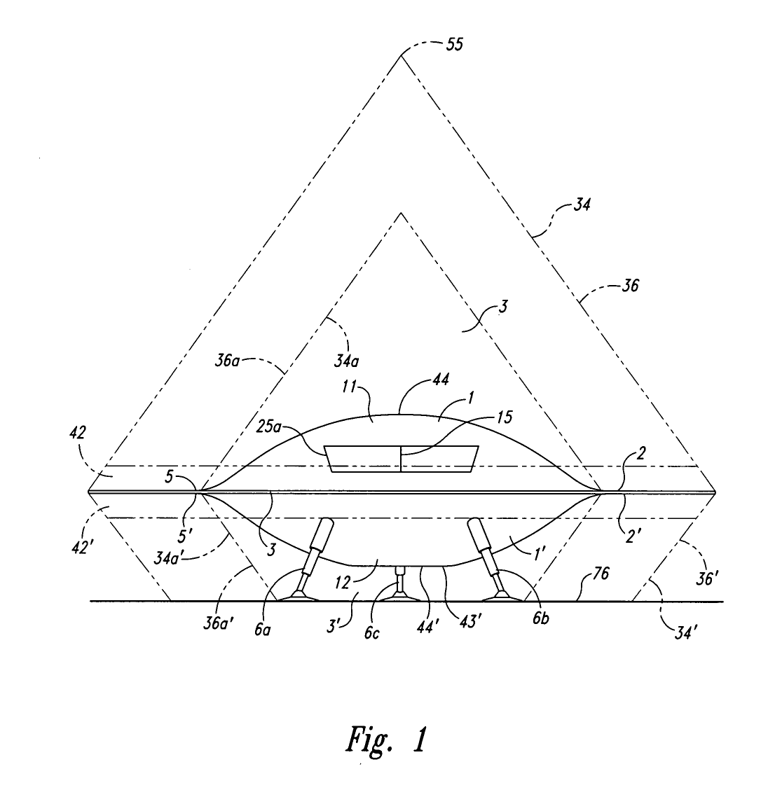

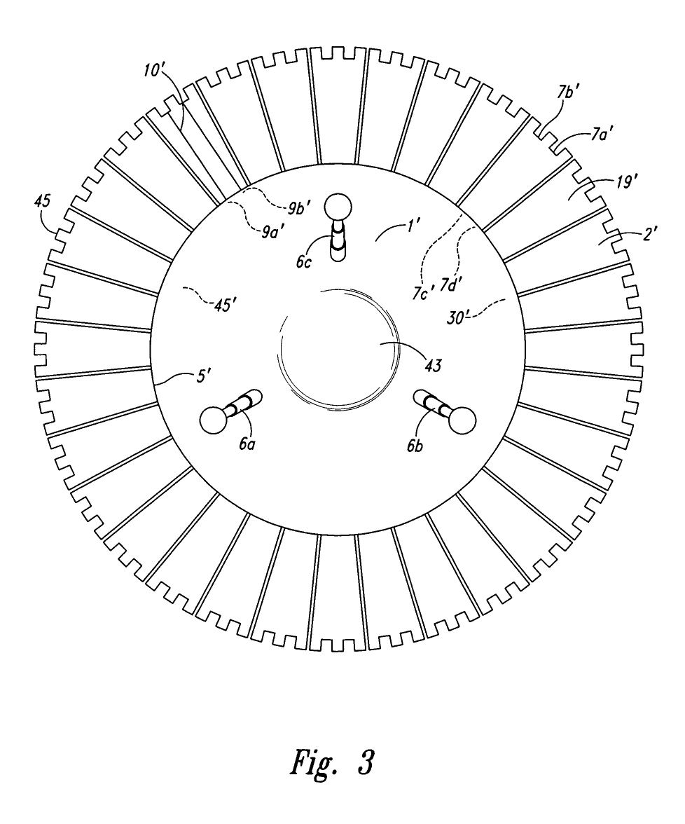

Operation of the aircraft. Referring to FIGS. 1, 2 and 3, a multi-functional aircraft (MFA), also called craft or device, is shown. From the side, aircraft has a lenticular shape, as shown in FIG. 1. When viewed from the top, said aircraft has a circular shape as shown in FIG. 2. When viewed from the bottom, aircraft has a circular shape as shown in FIG. 3. Said aircraft is comprised of a top half body hull 1, FIGS. 1 and 2, and a bottom half body hull 1′, FIGS. 1 and 3.

Referring to FIGS. 1, 2, 3, 4, and 5, a multi-bladed annular ring 2, 2′, also called bladed ring assembly 2, 2′, or ailerons 2, 2′, or annular ring 2, 2′, additionally called ring assembly 2, 2′, or ring 2, 2′, is located between bottom portion of top half of hull 2, and the upper portion of the bottom half of hull 1′. Individual blades in the ring assembly 2, 2′, are called blade 2, 2′, individual blades are also called aileron 2, 2′.

The bladed ring assembly 2, 2′, possessing a high electric field, and possessing uninsulated field windings 10, 10′, FIGS. 2 and 3, around said blades will produce an abundance of particles and ions.

The extensive capacitor system will immediately upon starting impart a high electric field, and an induced magnetic field around said blades.

An abundance of particles and ions will be produced by the uninsulated current within said field windings. Said particles will be warped into perpendicular Larmor gyro orbiting particle fields, a plasma field, 34, 34′, FIG. 5, around the aircraft. Said plasma field is perpendicular relative to the parallel magnetic field, lines of the craft applied magnetic field. It is an opaque particle field, as plasmas absorb all electromagnetic radiation in the visible spectrum, it is not reflected. In fact, plasmas absorb the electromagnetic radiation they produce, as well. In FIG. 1 a Larmor orbiting particle field is shown as a band 42, 42′, forming above and below the bladed ring assembly 2, 2′, upon starting. More energetic particles have formed the top vortex, lifting craft upward. As the bottom vortex forms, the craft is further lifted upward as the motional direction for movement for both vortices is upward using the right hand rule. The band 42, 42′ is not visible, it demonstrates the forces lifting the aircraft off the ground. There are bands of varying charged particles, bands of different charge, but too many to graphically represent.

The Larmor orbiting particles are in orbits around said aircraft, increasing in energy to the speed of light. Over time, the number of rotating particles will increase. The plasma field 34, 34′ is part of the oscillatory circuit of the craft. Said plasma is an oscillatory,.inhomogeneous plasma field, similar to a magnetically contained, confined, homogeneous plasma field, in that both fields can contain a spherical plasma. The magnetically confined plasma for a transitory period of time, the oscillatory, inhomogeneous plasma, for much longer. Nonhyperdynamic equations from craft electromagnetic oscillatory system, can be used in lieu of the unascertainable equations of the hyperdynamic, inhomogeneous plama field, to control the field. Both oscillatory systems are connected, FIG. 5.

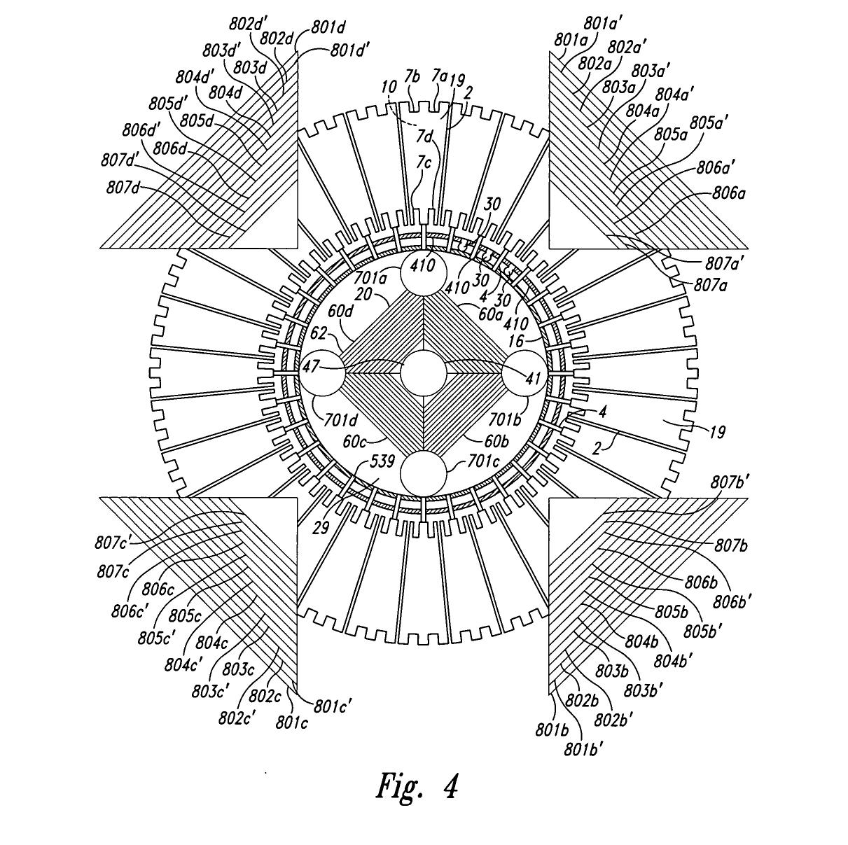

The preferred embodiment for the capacitors in the capacitance system is seven sets of four capacitors connected in parallel, a total of 56 capacitor plates. Though seven sets of four capacitors is only seven times as great as one set of four capacitors, it has 70 times as much magnetic force. A single set of the top four capacitors, one set of four capacitors, is depicted in FIG. 4 as capacitors 701a, 701b, 701c and 701d. Additionally, eight smaller capacitors connected in parallel, 70a, 70b, 70c, 70d, 70e, 70f, 70g and 70h, are depicted in FIG. 9 arrayed around central shaft 41, FIG. 9. The capacitance potential of said larger, similar aircraft, to be described, is more than double the smaller craft, without the increased size being a factor.

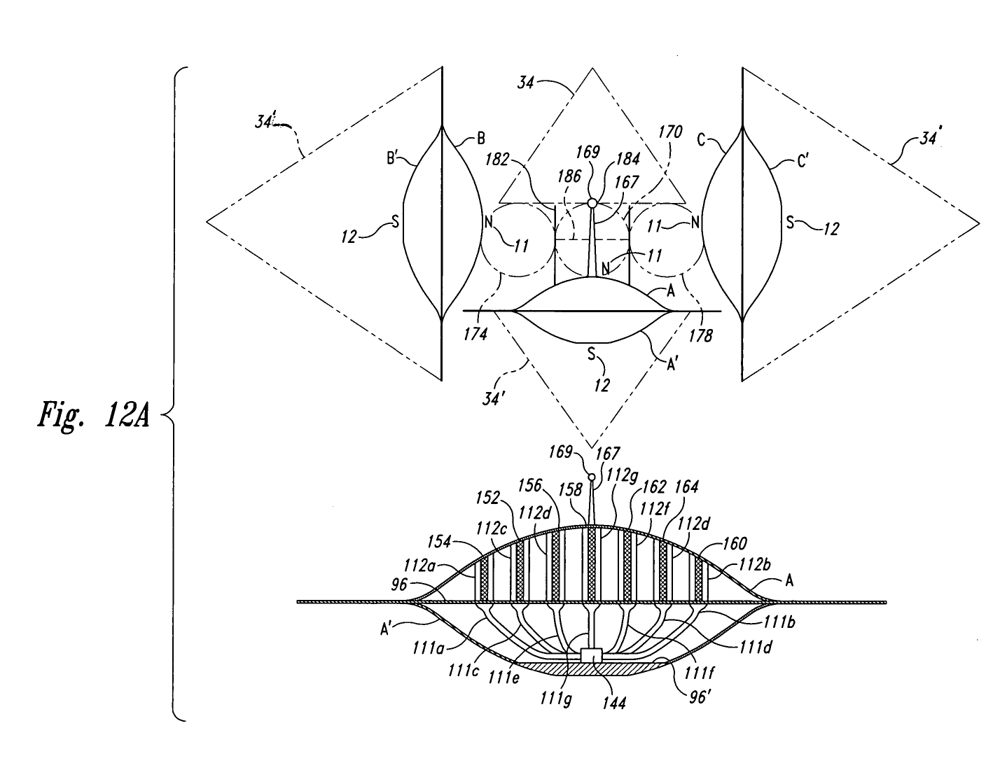

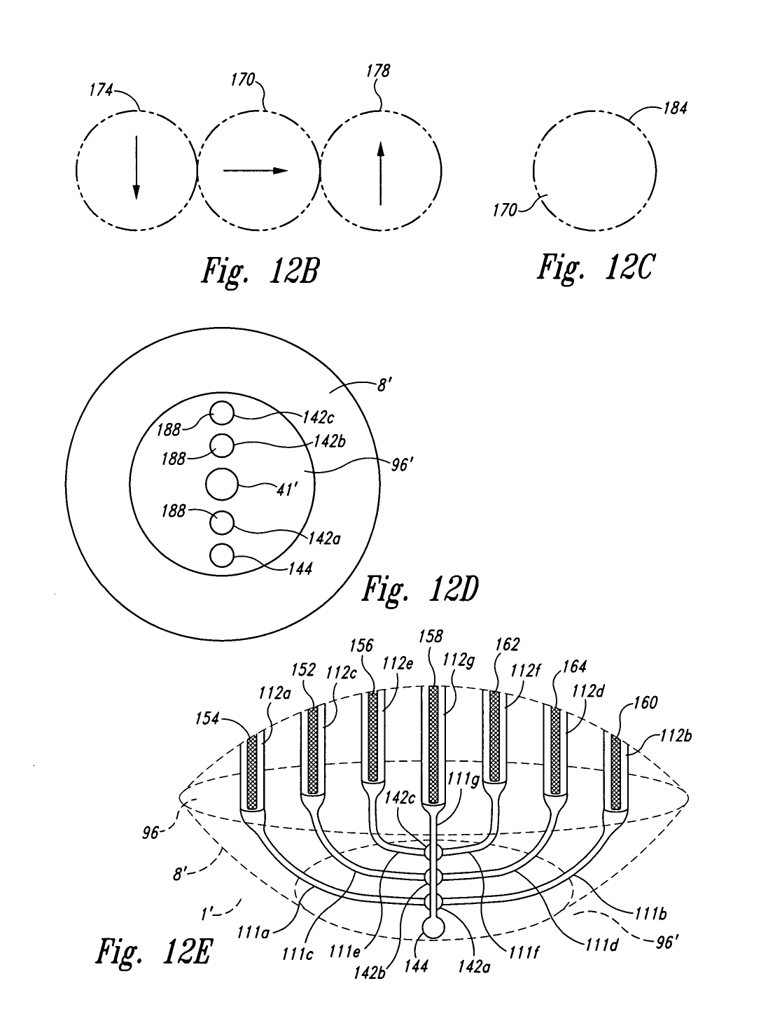

The following aircraft systems will be connected in sequence: Bladed ring assembly 2, 2′, FIG. 4, the blade axel system 4, FIG. 4, a blade attachment ring 26, FIG. 4, the plurality of large capacitors 701a, 701b, 701c, 701d, and 702a, 702b, 702c, 702d, and 703a, 703b, 703c, 703d, and 704a, 704b, 704c, 704d, and 705a, 705b, 705c, 705d, and 706a, 706b, 706c, 706d, and 707a, 707b, 707c, and 707d, FIG. 5, the eight small capacitors 70a, 70b, 70c, 70d, 70e, 70f, 70gand 70h, FIG. 9, the induction coil, also called electric coil 47, 47′, FIG. 5, and the interconnecting electric system 20, FIGS. 4 and 5. Said electric coil will be comprised of thick coils, obviating necessity for a large, central magnetic core within coils, a solid core. Thick metallic coils are preferred embodiment. Also within the electric system 20, is the electrolysis system possessing an electrode 188, FIG. 12D. Said ferromagnetic cores within electrolysis system will increase in magnetic intensity due to orbiting ions, however, during fusion process, the requirement for particles to be placed in mini-Larmor orbits, will require, that after initial formation of orbiting Larmor particle fields, said particles have to be maintained in orbit around said ferromagnetic cores, increasing magnetic intensity of cores. At the onset of fusion process, said cores will have increased in magnetic intensity to permit formation of mini-Larmor orbits that will persist after charged particles exit from roof of aircraft. Said spiralling ions will coalesce into a spherical plasma.

Electromagnetic radiation 44, 44′, FIG. 5, emitted from top and bottom of craft from induction coil, will be absorbed in large part by the overarching plasma fields.

Said electromagnetic systems will be accompanied by plasma systems operating concurrently, said plasma systems include: Plasma produced by uninsulated bladed ring assembly 2, 2′, FIGS. 3 and 4, plasma produced by large and small capacitors, said plasma produced by small capacitors in large part to be utilized by plasma gun 64, FIG. 9, said plasma produced by large capacitors to be used in large part in formation of said plasma field 34, 34′, plasma produced by internal electrolysis system producing ions, in effect, plasma. The referenced radial plasma gun 64, will have a large pulsed current as the fluctuating direct current of the aircraft, produces a powerful plasma system for the co-axial plasma gun, also called tube. Said plasma tube will produce sudden plasma propulsion capable of extreme speeds.

As the electric system of this aircraft is capacitor based flutuating direct current, there will be an alternating current component. The current appears to move in one direction, but it will be moving in two directions. The initial torque in starting will evidently carry over and remain manifest, in one direction.

Referring to FIG. 1, the encircling plasma fields of this craft will affect this steel hulled craft the same as electric coils around a steel cored electromagnet. As the energy of the Larmor orbiting particle fields increase in energy, there is a concomitant increase in the magnetic intensity of the chromium steel hull of the aircraft. High magnetic fields will be approached by the aircraft in this manner. These high magnetic fields will translate into elevated electric fields and electric currents.

The preferred embodiment for material composition of the blade 2, 2′, FIGS. 2 and 3, is tungsten cobalt alloy with zirconium. This material tolerates high fields and high temperatures. The preferred embodiment for the field windings around said blades is hammered tungsten wire. Said wire is a conductor and can tolerate high fields. On-going research has indicated that high field conditions are approached with tungsten's high magnetoresistivity. Tungsten also has the highest melting point of the metals. Tungsten, though usually brittle, becomes pliable with hammering or other process, rendering it suitable as a wire. The array of field windings 10, 10′, FIGS. 2 and 3, will wrap the blades 2, 2′, called blade cores 19, 19′, FIGS. 2 and 3. When wrapped with said field windings, or when referring to the blades under said field windings, said blades are called blade cores. The array of field windings will wrap the tungsten, cobalt zirconium blade cores, preferred embodiment, of bladed ring assembly. When the ferromagnetism of the applied magnetic field of the smaller aircraft is lost at high fields, the tungsten based electric current in the bladded ring assembly will persist, and intensify. The diamagnetic magnetic field of the plasma 34, 34′, receives its energy from the applied magnetic field of the craft.

After the ferromagnetism of the craft is lost at high fields, the magnetic field of the annular ring assembly 2, 2′, will continue to increase to high fields. Said electric ring assembly also possesses an extended magnetic field beyond the magnetic field 49,

FIG. 5. Said ring magnetic field is shown on both sides of said aircraft in FIG. 5. Said circular ring field lines will expand out from both sides of aircraft, 49a and 49b, FIG. 5, and will meet in the center of said aircraft. Said field lines will overlap the field lines of the applied magnetic field, said magnetic north and south pole will be intensified at that time.

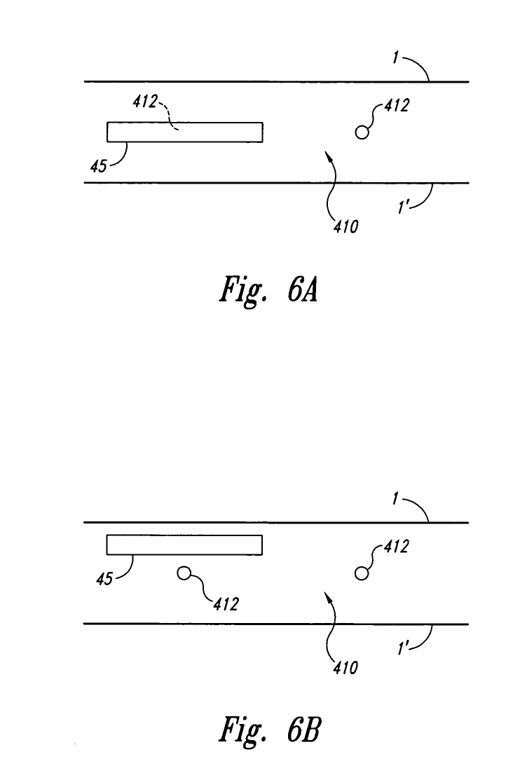

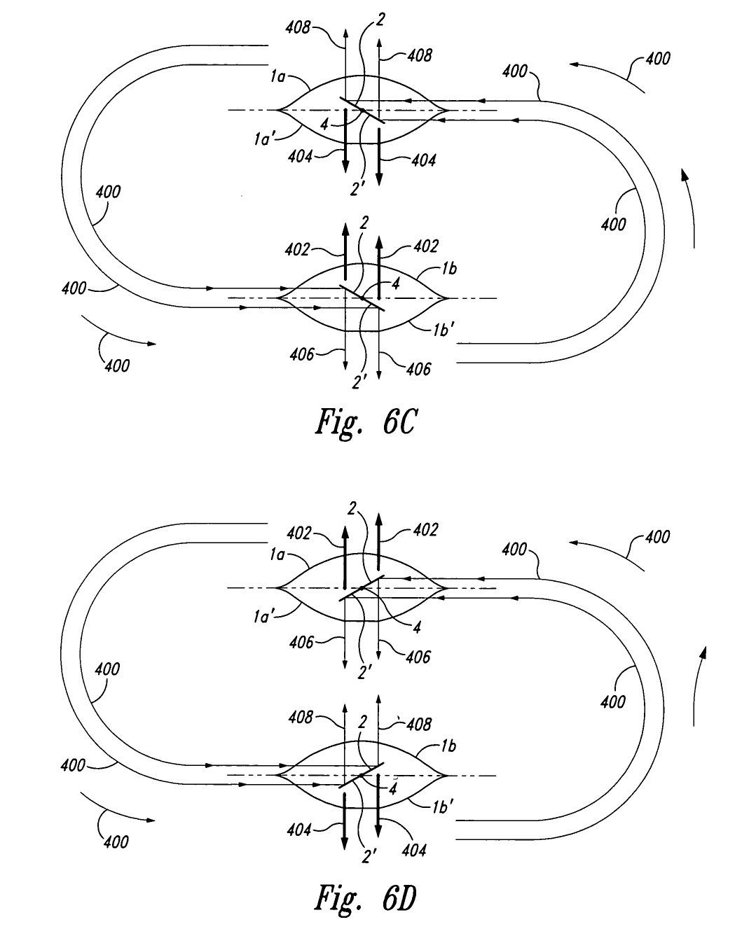

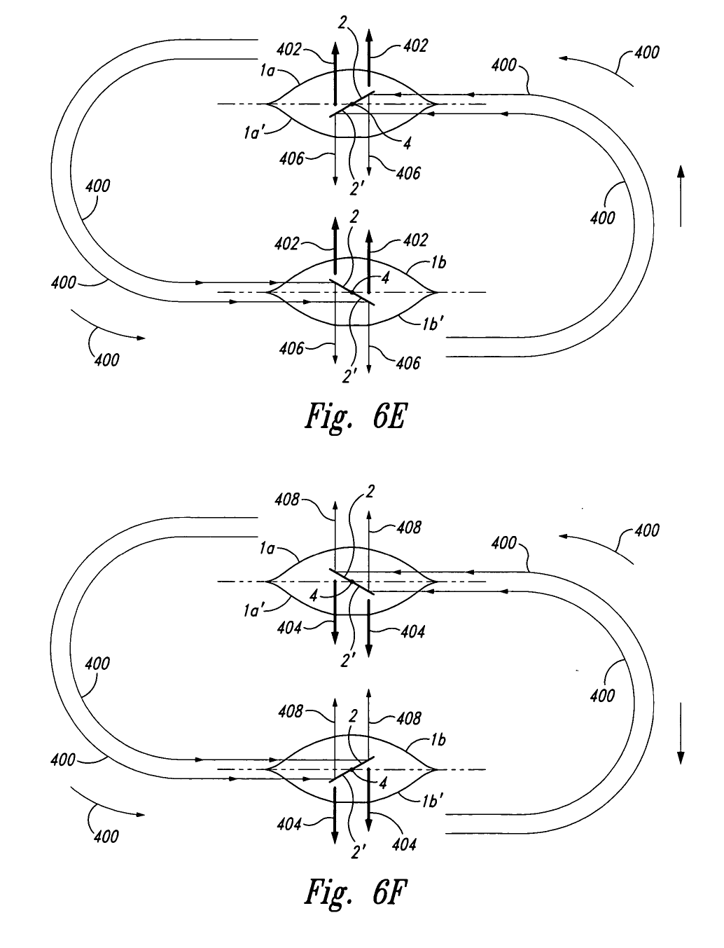

Referring to FIGS. 6C, 6D, 6E and 6F, the aircraft 1b and 1b′ is shown in a sideview, showing the end of aileron positioned over axel 4 in FIG. 6C. On the opposite side of aircraft 1b, 1b′ , is aircraft 1a, 1a′, which is a cross section side view showing an aileron 2, on the exact opposite side to blade 2, on aircraft 1b, 1b′ . The Larmor gyro orbiting particles are rotating around the two halves of same aircraft. The particles impact aileron 2 on aircraft 1a, 1a′. The-same path of orbiting particles 400 impact aileron 2 on aircraft 1b, 1b′ , only this impact is on the opposite side. These are the two sides of same aircraft. This is a banking procedure for this single aircraft. One aileron is turned up as shown in FIG. 6C, the blade on the other side is turned up exactly the same, but the particles are impacting opposite sides of these ailerons even though they are turned exactly the same.

In conventional aircraft, one aileron is turned up and on the other side, the blade is turned down. The explanation for aircraft 6C, is that the particles are moving in opposite directions on each side of the aircraft, as shown. Said ailerons are conducting, the blades possess a charge. The dominate charge of the ailerons is negative from electric current in field windings on the ailerons. The negative current attracts the large positive charges, and repels the negative charges with repulsive force. The large attraction for positive charges results in impacts on the negative ailerons as shown within. FIGS. 6C, 6D, 6E and 6F. The equally significant repulsive force against the equally fast, if not faster, electrons, is met by a combined repulsive force between the two negative charges. Abrupt maneuvering, much faster than aerodynamic forces on a conventional aileron or flap, are possible.

The opposite side of impacted aileron is not facing Larmor particle field flow to the same degree, effect is less.

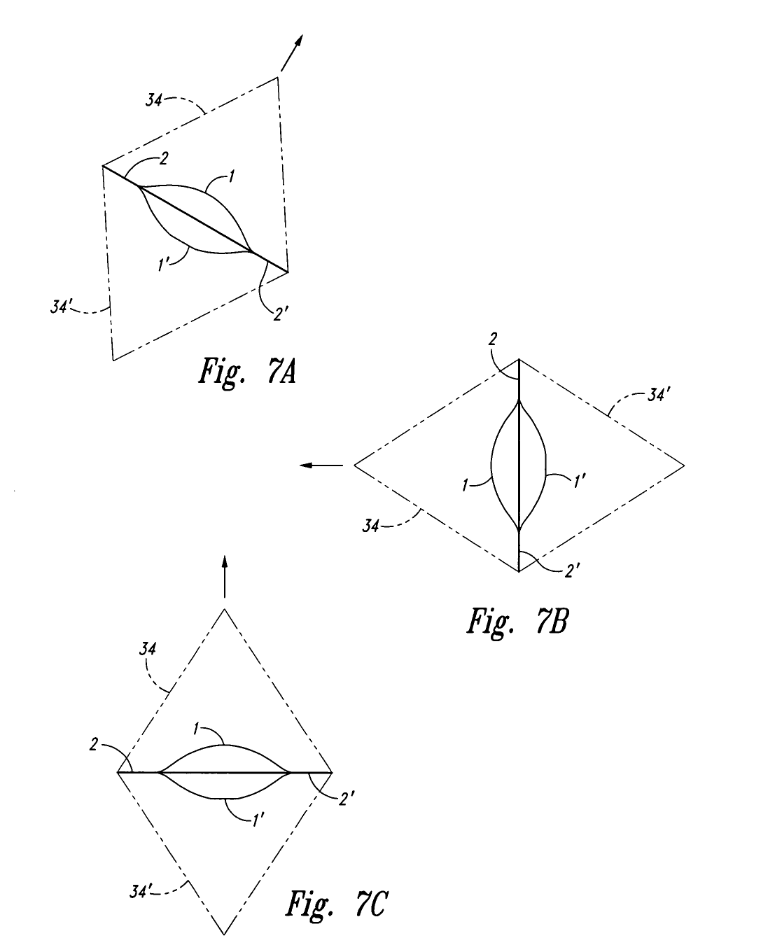

Referring to FIGS. 7A, 7B and 7C, propulsion or flight by use of rotating vortices of the plasma fields 34, 34′, FIG. 1, is shown. By utilizing ailerons for positioning the aircraft, as shown in FIG. 7A, and by increasing energy from the capacitance or inductance systems to the vortices 34, 34′, FIG. 1, thereby increasing rotation of vortices, motional flight can be commenced.

The motional direction of vortices 34, 34′ in FIGS. 7A, 7B, and 7C, is in direction as indicated by arrow. The rotational direction of both vortices, is to the right when viewed from bottom, the earth.

Extreme speed is possible with this mode of flight. Increase in vortex rotation leads to a lengthening of vortex.

Referring to FIGS. 7A, 7B and 7C, descent mode for rotating vortex method of propulsion begins with a descent in altitude. Flight to intended landing site is similar to a helicopter maneuver for landing. Stopping directly over intended descent site, rotation of the vortices is slowed, slowing in rotation of vortices will rock the craft from side to side as it slows. Ailerons 2, 2′, FIGS. 2 and 3, can be utilized to navigate the craft during descent.

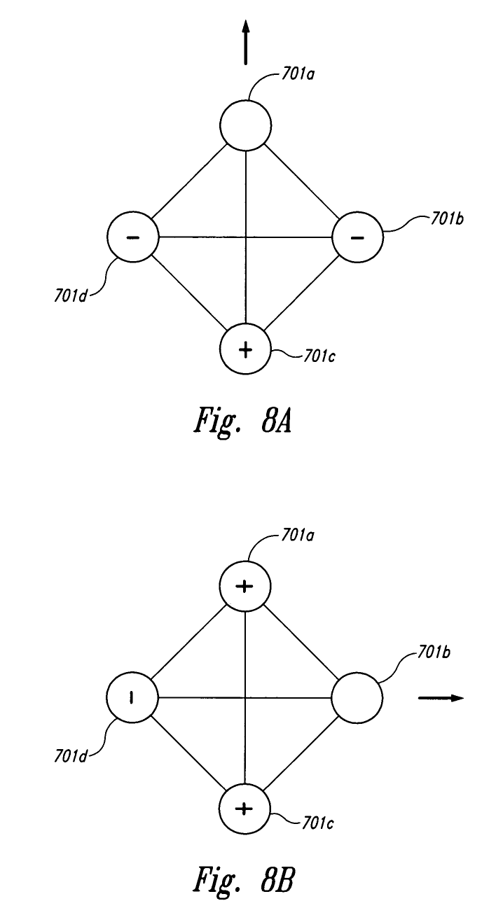

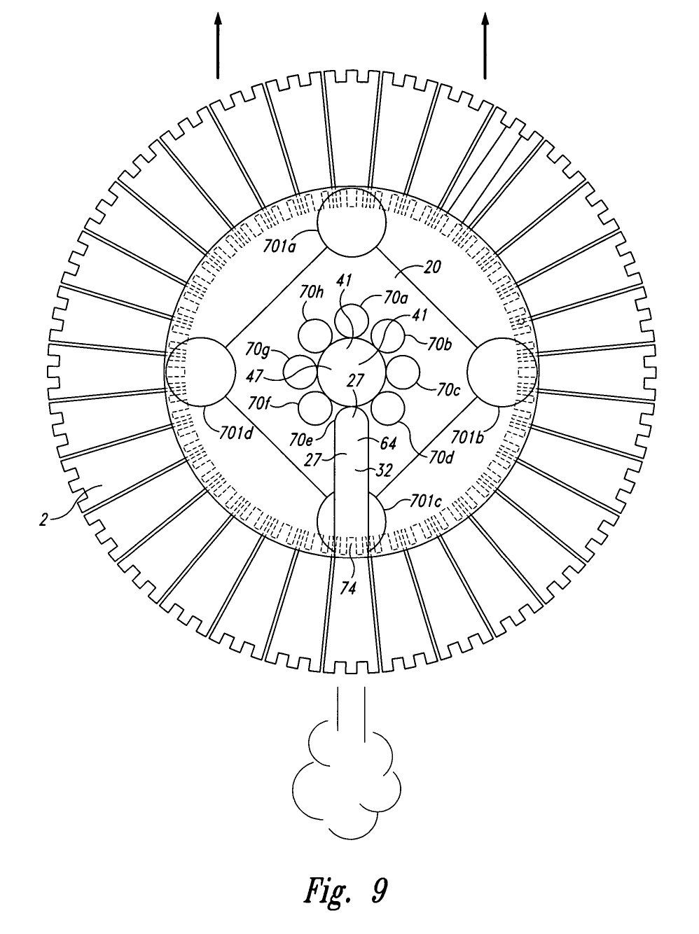

Referring to FIGS. 8A and 8B, utilizing capacitors as electrodes with electrode levitation as advocated by Dr. T. Townsend Brown, with the high fields this aircraft will develop, does become feasible. Capacitors will be aluminum material. Aluminum and magnesium have among the highest ionization potentials of the metals, Aluminum is preferred material for capacitors. The dielectric for capacitors will be a vacuum existing under over-arching vortices permitting a high breakdown voltage in capacitors. Such a propulsion system would provide complete silence, and, if there was absence of moonlight or the weather overcast, completely soundless and invisible incursions would be possible. The capacitors are contained within the aircraft, they would not be visible. Titanium dioxide compound can be used as dielectric.

The craft would also be invisible to radar as plasmas absorb all electromagnetic radiation, including the radiation they generate. An insulated trailing wire outside the plasma vortices would be required to receive or transmit signals or visual spectrum. It can be deployed when needed. An antenna, trailing wire, originates from the bottom area of craft in preferred embodiment. It will hang down the full length of the funnel shaped bottom vortex. Below the insulated portion, the wire will be uninsulated a short distance. An antenna can be deployed above the magnetic north pole of the craft. Electromagnetic radiation penetrates this area, the light is polarized by magnetic pole.

In electrode propulsion, movement, is toward the charged electrode. T. Townsend Brown demonstrated the effect, and has numerous patents pertaining to this invention. He lacked extremely high fields, this invention will make possible this form of propulsion. Movement toward the more highly charged electrode is shown in FIGS. 8A and 8B. The electrode or the electrodes most highly charged determine the direction of movement. One of the four electrodes will not possess a charge, as indicated by lack of a charge sign within center of electrode.

Referring to FIG. 9, the aircraft has a fluctuating direct current with a large pulsed current. Plasma 27 will be produced by ionization on the uninsulated multi-bladed annualar ring assembly 2, 2′, FIGS. 2 and 3, Plasma 27, FIG. 9, is also produced from uninsulated current on field windings 10, 10′, FIGS. 2 and 3, and also from the large and small capacitors and the electric coil throughout the central shaft. A co-axial plasma gun 64 will extend from one of the eight small capacitors, 70a, 70b, 70c, 70d, 70e, 70f, 70g, and 70h, surrounding the crew access tube 41, 41′, FIG. 5, parallel with the middle set of large capacitors, to one of the opposing large capacitors. The plasma 27 will run the length of tube 64. The fluctuating direct current provides a pulsed current, said current is the most powerful plasma current for plasma propulsion and use underwater as well. A strong plasma current 27 will run the length of tube 64 as a radial electric current is moving with it. This prolongs the Lorentz force in combination with the magnetic field. Plasma 27 will eject at the outer end 74 of tube 64. Utilizing Lorentz force, the craft will be propelled with extreme speed. The plasma tube 64 can be moved to all sectors around perimeter of the craft.

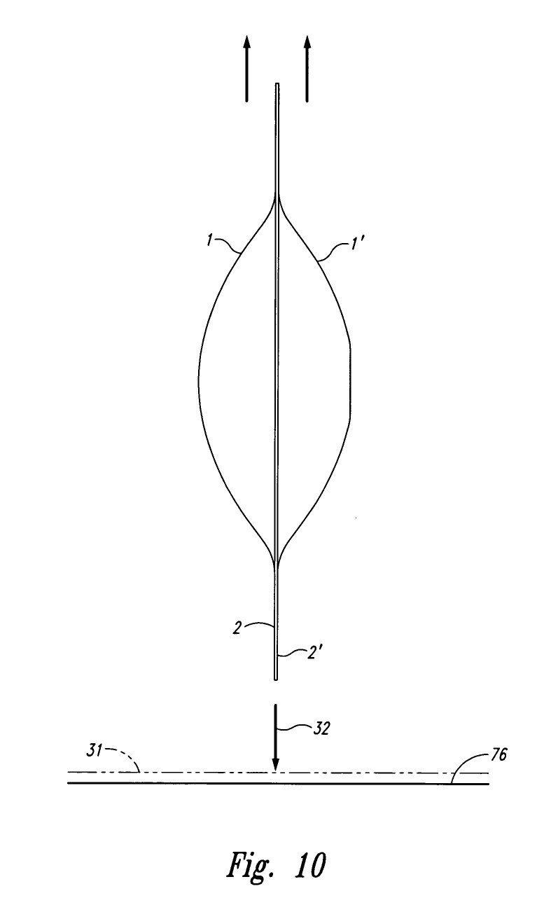

Referring to FIG. 10, the aircraft is shown in a perpendicular position relative to Earth 76. In this position, the electric field of the craft is interacting with Earth's magnetic field at a ninety degree right angle, resulting in maximum repulsive force between the craft's electric field and magnetic field of the Earth. The high fields of this aircraft, make this form of propulsion possible. Extreme acceleration perpendicular to the Earth is possible in this mode of propulsion.

The high magnetic field induced in aircraft by the rotating Larmor gyro orbiting particles will also increase the electric field in bladed ring assembly 2, 2′, FIGS. 2 and 3. The chromium steel hull 1, 1′, FIG. 1 will be magnetized like an electromagnet.

End of operation section of aircraft preferred embodiment.

Beginning a description of the preferred embodiment of aircraft:

Referring to FIGS. 1, 2, 3, 4 and 5, a preferred embodiment of the Multi-functional Aircraft (MFA), also called aircraft, craft, or device, is shown. The aircraft is comprised of a body hull 1, 1′, FIG. 1, comprising a top half hull 1, FIGS. 1 and 2, as well as bottom half hull 1′, FIGS. 1 and 3. A bladed ring assembly 2, 2′, FIGS. 1, 2 and 3, is mounted between the top and bottom half hulls 1 and 1′. An individual blade 2, 2′ is shown in FIG. 4, at 12 o'clock in ring system, attached to an axel, 4, FIG. 4, and said axel to blade attachment ring 16, FIG. 4, to connecting portion of the blade attachment ring 16. All 32 of the blades in bladed ring assembly 2, 2′ are pivotally attached to blade attachment, ring 16. The bladed ring assembly 2, 2′ is connected to said capacitors by electric system. Said capacitors are in turn connected to electric system 20, FIG. 4. A conducting electric system, is also called electric system. Said electric system 20, further comprises capacitor plates 701a,a′, 701b,b′, 701c,c′, 701d,d′, and 702a,a′, 702b,b′, 702c,c′, 702d,d′, and 703a,a′, 703b,b′, 703c,c′, 703d,d′, and 704a,a′, 704b,b′, 704c,c′, 704d,d, and 705a,a′, 705b,b′, 705c,c′, 705d,d′, and 706a,a′, 706b,b′, 706c,c′, 706d,d′, and 707a,a′, 707b,b′, 707c, c′, and 707d,d′, FIG. 5.

Said capacitor system in FIG. 5, is connected by electric wires 801a, 801b, 801c, 801d, and 802a, 802b, 802c, 802d, and 803a, 803b, 803c, 803d, and 804a, 804b, 804c, 804d, and 805a, 805b, 805c, 805d, and 806a, 806b, 806c, 806d, and 807a, 807b, 807c, and 807d, FIG. 4.

A complete complement of said capacitors further comprises connecting electric wires 801a,a′, 801b,b′, 801c,c′, 801d,d′, and 802a,a′, 802b,b′, 802c,c′, 802d,d′, and 803a,a′, 803b,b′, 803c, c′, 803d,d′, and 804a,a′, 804b,b′, 804c,c′, 804d,d′, and 805a, a′, 805b,b′, 805c,c′, 805d,d′, and 806a,a′, 806b,b′, 806c,c′, 806d,d′, and 807a,a′, 807b,b′, 807c,c′, and 807d,d′, FIG. 4.

Said capacitor system in FIG. 5, is connected by electric system 20, FIG. 4, to the top and bottom of induction coil 47, 47′, FIG. 5,

The four quadrants of said electric system 20, comprising quadrants 60a, 60b, 60c, and 60d, FIG. 4, pertains to capacitors.

Said electric system 20, FIG. 4, also includes electric wires in FIG. 9,. connecting said small capacitors in parallel 70a,a′, 70b,b′, 70c,c′, 70d,d′,,70e,e′, 70f,f′, 70g,g′, and 70h,h′, around central shaft 41, 41′, FIG. 5. Said electric system 20, FIG. 4, also includes electric wires to hull 1, performing as one of the extra large capacitor plates in parallel and opposite Langmuir sheath 36, with intervening space as the dielectric, and electric wires to hull 1′, performing as an extra large capacitor plate in parallel and opposite Langmuir sheath 36′, with intervening vacuum, the dielectric. A wireless electromagnetic connection exists within the oscillatory circuit to said Langmuir sheaths. Within the magnesium hulls of the larger similar craft, to be referenced in a later section of this paper, said extra large capacitors within said hulls, will have added significance. The intervening vacuum is the dielectric for plasmas.

Referring to FIG. 1, the top most point on top vortex 34, is apex 55, on bottom vortex 34′, the bottom most point after it develops is apex 55′ An extra sharp edge of the hull, a lip 5, 5′, permits accumulated pooled current, electric charge on top and bottom hulls of craft to be exhausted onto the annular ring surface, 2, 2′. In reference to FIG. 4, blade notches 7a, 7b, 7c, 7d, and 7a′, 7b′, 7c′, and 7d′ are for field windings 10, 10′, FIG. 2, current entering field windings at weak current entrance 9a, FIG. 2 and exiting at strong current exit 9b, FIG. 2. When the diamagnetic magnetic field of the Larmor orbiting particle field moves across the field windings 20, increased current is produced in weak current 9a, and exits as strong current 9b, alternately. The applied magnetic field has non-moving poles, with an alternating current componant. Preferred embodiment for wire for field windings 10, 10′ will be hammered tungsten wire over a blade core 19, 19′, FIGS. 2 and 3, of tungsten, cobalt zirconium alloy. Said blades 2, 2′ also act as ailerons 2, 2′ for navigation of aircraft. Nozzles 30, 30′, FIGS. 2 and 3, placed between blades, are above and below blades on the hull exterior surface 1, 1′. Said nozzles are to extinguish fire or incipient combustion forming on blades due to high temperatures. Openings 410, FIG. 6B, are to extract and replace blades through said opening. Landing gear 6a, 6b, and 6c, are shown in FIGS. 1 and 3. Said landing gear can be extracted into or out of area within area of lower deck 96′, FIG. 5, and lower deck wall 8′. Shown in FIG. 3, is soft landing surface 43, FIG. 1, indicated as circular dash lines on bottom of craft hull 1′, FIG. 3.

Referring to FIG. 5, circular, induced magnetic field 49a and 49b, FIG. 5, which are opposite sides of the same magnetic field 49, surround blade assembly ring 2, 2′. An upper deck floor 96 and a lower deck floor 96′ are shown. The top of the electric system 20, is shown on planar surface of top of the bottom half of hull 1′. Interior walls of hull 1, 1′ are covered with an octagonal structural frame of beehive configuration 8, 8′, FIG. 5, of the same material as hull 1, 1′. Cabin doors are shown for access to lower and upper deck. Access to cabin door 26b to lower deck and upper level cabin door 26a is from crew access tube 41, 41′, FIG. 5. This hollow cylinder also serves as a central support shaft 41, 41′ for both upper and lower hulls. The crew access tube 41, 41′ also serves as a pressure release tube 41, 41′, FIG. 5, during a nuclear fusion reaction process. The crew access tube 41, 41′, also serves as a surface for electric coil 47, 47′, also called induction coil. Said central shaft 42, 41′ also has recessed, curved hand and foot bars 57, for ascent and descent within crew access tube, during entrance or exit to crew hatch doors 23a and 23b to top and bottom decks, FIG. 5.

Referring to FIG. 5, depicted is an electrolysis system with column 111a, 111b, 111c, 111d, 111e, 111f, and 111g. Above are connecting columns 112a, 112b, 112c, 112d, 112e, 112fand 112g. Two columns in numerical sequence attach sequencially to 142a, 142b, and 142clocated behind barrel 144, in center of said aircraft. Said electrolysis system will be described in detail in a fusion portion of this patent. Said electrolysis system is used within an atmospheric environment to produce energy from a nuclear fusion reaction without significant radiation or heat, In a non-atmospheric environment, said electrolysis system can produce plasma vortices from water or other liquids or ice, as a means for propulsion by vortex action, or to produce an atmosphere within a larger domed environment, or to produce heat or visible light within a larger domed or other environment. Said electrolysis system in FIG. 5 operates within earth's atmospheric environment with water and seawater as potential fuels.

The pilot window 25a, FIG. 5, is comprised of glass comparable to a deep diving bathysphere. Similar glass comprises rear window 25b, FIG. 5. Said window 25a is for the pilot, rear window 25b is for the pilot as a rear window, and also for the crew. Pilot and co-pilot share the same window. Said window will be divided by a center line to delineate areas of assignment for pilot and copilot. Center line 15, FIG. 1, is perpendicular with bottom of window. Energy can be stored within craft capacitance and inductance systems. The magnetic field is formed from magnetism remaining in said preferred chromium steel hull, And from the magnetic poles formed by the craft oscillatory circuit. Said hull is similar to an automobile bumper in that it will reflect the sky. When entering crew access tube, also known as central shaft or induction coil, said crew must wear heat resistant, non-conducting suits and gloves with helmets. Extreme ionizing effect will persist after departing craft through said shaft. Higher ferrochromium steel can also be used for hull.

Referring to FIG. 5, engineer control panel 540 is located on upper deck. Said panel will contain diagnostics for plasma and controls for said engineer, part of crew. Instruments and gauges 542 for pilot aircraft control will resemble those of conventional aircraft, and will include the most advanced flight control systems 539, FIG. 5. Engineer area is 114, pilot area 113, FIG. 5.

The Larmor gyro orbiting particle field 34, 34′, FIG. 5, is produced by ions from the uninsulated blade assembly ring, FIG. 5, primarily. Said ions depart said assembly ring at 25,000 volts, at a Lorentz angle, right angle to craft electric and magnetic fields. Said ions are warped into perpendicular Larmor gyro orbits around said craft within the applied magnetic field of craft. Ions the length and width of said bladed ring assembly will be emitted. Said ion field will be the length and width and circumference of said blade assembly ring. Said ion field will be emitted on top of said ring assembly, and on bottom of said bladed ring assembly. Said Larmor plasma field 34, 34′, will be turning to the right when viewed from the bottom of craft. Both the top vortex 34, and bottom vortex 34′, will be turning to the right. The motional direction for movement of the craft is up by the right hand rule, for both the bottom and top vortex fixed within craft magnetic field.

Said Larmor gyro orbiting plasma field is covered by a Langmuir sheath, 36, 36′, FIG. 5, to a depth of the Debye shielding length. Said Langmuir sheath will be forming on the inside of said plasma, said outside of plasma being the distance from inside, the width of said bladed ring assembly. This being the case, a vacuum can be formed within said plasma to facilitate formation of a fusion spherical plasma. Said vacuum 3, 3′, FIG. 1, inside interior Larmor orbiting particle field 34a, 34a′, FIG. 2, and interior Langmuir sheath 36a, 36a′, FIG. 1, includes bottom and top surface hull 1, 1′, FIG. 1, within vacuum area.

Said vacuum forms in this area immediately upon formation of said Larmor plasma vortices. The vacuum persists. Upon formation of said vortices, the ambient particles within the vacuum areas, are rapidly energized by the magnetic field and the electric field. Natural drift will also rapidly place said free particles within the orbiting Larmor particle fields. Frequent collisions accelerate the process. When this craft lands in an area with small water deposits on the earth, said small ponds will freeze over, even in the summer. This effect is a vacuum effect. Area between the hulls is also a vacuum.

The ponderomotive effect, other effects, contibute to the natural formation of spherical plasmas within said vortices. Spherical plasmas formed within the bottom vortex will be constantly lost due to gravity. Spherical plasmas forming on roof of said craft will most likely persist indefinitely. Said energy can be utilized, or grounded if not required. Over time, the accumulated energy within spherical plasmas may require landing to ground energy to earth. During the fusion process said large craft will use an electrolysis system.

The fusion spherical plasma should remain centered around raised pyramidal cone. The electric field from the ball electrode should isolate the fusion spherical plasma within the vacuum area on top of said aircraft. Non-fusion spherical plasma most likely form in the apices of said vortices. Said plasmas will have a Langmuir sheath.

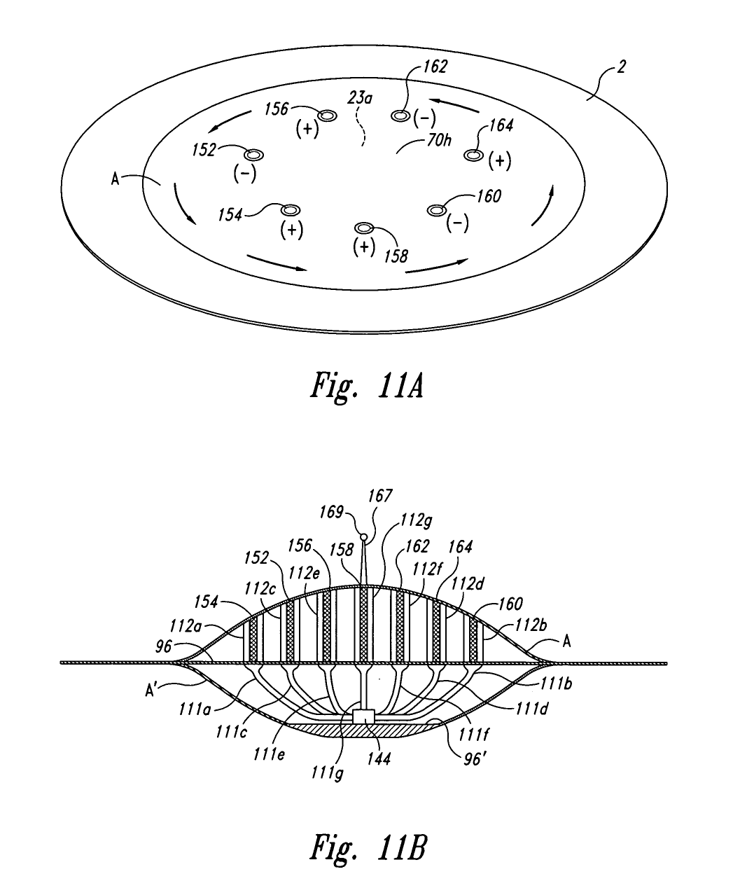

Referring to FIGS. 4 and 5, the bladed ring assembly 2, 2′ is connected to electric system 20, the electric system 20 is further connected to extended capacitor systems. Said electric system is connected to top and bottom of said induction coil, said electric coil emitting electromagnetic radiation, comprising an extension of said electric system. Upon raising the pyramidal cone 167, FIG. 11B, a further extension of the electric system will exist. Said system is also connected to hulls 1, 1′.

Referring to FIG. 6A, a plurality of holes 412 through blade attachment ring 16, FIG. 4, to insert a plurality of axels 4, FIG. 4, is shown. Said axels are attached at opposite end to a plurality of blades 2, forming a bladed ring assembly of 32 blades, 2, FIG. 4. Said holes 412 will be insulated to insulated axel 4 from connected ring 16. Said axel 4 attaches to blade end 45 of blade 2 through hole 412 as shown by read line to hole 412 located behind the center of blade end 45. Also shown is opening 410, FIG. 6A to extract worn or burnt blades through area between the hulls 1, 1′. Said area comprising opening 410.

Referring to FIG. 6B, blade end 45, FIG. 2 of blade 2 is shown in opening 410 between hulls 1, 12′ being removed above hole 412 as a smoking or worn blade to be replaced.

Referring to FIG. 6C, a single aircraft is shown. A side view of half of the craft 1b, 1b′ , and a cross 'section of the remaining half of the craft 1a, 1a′, are shown. The front half of blade is slanted down, the rear half of blade is turned up. Moving charged particles 400 in Larmor gyro orbits around said aircraft are shown. Particles 400 impact the bottom of the blade on axel 4 of aircraft 1b, 1b′ and are reflected downward 406 on entire bottom portion of blade on axel 4. The bottom impact on aileron 2 by particles 400, produces an opposite and equal reaction movement in opposite direction. The blade and aircraft on half of aircraft 1b, 1b′ are moved upward. On the opposite side of aircraft 1a, 1a′ orbiting particles are now moving in the opposite direction relative to aircraft 1b, 1b′ . The aileron 2, 2′, FIG. 6C on aircraft 1a, 1a′ is in the same position as the blade 2, 2′, FIGS. 2 and 3, on the opposite side of aircraft 1b, 1b′. The moving particles 400 are now impacting the top of the blade and are reflected upward 408, simultaneously, the blade and aircraft are moved downward 404. This opposing movement on each side is a banking maneuver. It resembles conventional aircraft, but is an entirely new method of navigation. The blade at axel 4 will move upward into a more energetic particle orbit, and the other half of blade will; move downward into a more energetic particle orbit. The result will be instantaneous banking of the aircraft.

Referring to FIG. 6D, a single aircraft is shown. A split, front side view of aircraft is shown, and a cross section, split, rear side view of craft is shown at the top. The moving charged particles 400 are impacting the top of blade between axel 4.

Particles are reflected upward 408, opposite opposing force is downward 404. The other side of same aircraft, a cross sectional view, the moving charged particles 400 impact blade between axel 4 on the bottom. The particles are deflected downward 406, a reactive force upward 402, banks aircraft upward on the left, assuming aircraft is traveling to the right.

Referring to FIG. 6E, bottom craft is one side of an aircraft. An opposite cross sectional view of the side of top aircraft, is shown. Both views, top and bottom, are of one aircraft. Charged particles 400 are impacting blade at axel 4 striking blade bottom deflecting downward 406. The same particle orbit impacts the top aircraft aileron at axel 4 deflecting downward 406 with a reactive force upward 402. The aircraft will ascend in altitude. This operation is similar to the increase or decrease in alititude by the use of elevators within conventional aircraft. Elevators are located in the tail section.

Referring to FIG. 6F, a moving charged particle field represented by arrowed lines is impacting aircraft 1b, 1b′ on the top of the aileron on axel 4 deflecting particle upward 408, with an equal and opposite reactive force downward 404. The gyro orbiting charged particles impact aircraft 1a, 1a′ on the top surface of aileron on axel 4 deflecting upward 408 with an equal and opposite force downward on aileron and aircraft 404. The aircraft will descend in altitude.

Referring to FIG. 7A, a field of Larmor orbiting particles around craft hull 1, 1′ is shown. The aircraft in FIG. 7A has been positioned in direction of the arrow by using ailerons 2, 2′, FIGS. 2 and 3. The rotating vortices will move aircraft in the direction indicated by arrow. Increased energy to rotating vortices 34, 34′ will increase length of vortex 34′ and increase the rotational rate of both vortices. Said increased energy will also increase the speed of aircraft.

Referring to FIG. 7B, an aircraft with hull 1, 1′ has been positioned horizontal relative to the earth in direction of travel indicated by arrow. The aircraft has been positioned in a horizontal position by ailerons 2, prior to acceleration. The rotating vortices will move aircraft in direction indicated by the arrow. Increased energy to rotating vortices 34, 34′ will increase length of vortices and also increase the rotation of both vortices 34, 34′, and will increase the speed of aircraft.

Referring to FIG. 7C, an aircraft is shown having been positioned in a vertical position by ailerons 2, 2′, FIGS. 2 and 3. Direction of travel has been indicated by arrow. The aircraft is perpendicular to earth. The aircraft has been positioned by ailerons 2 prior to acceleration. The rotating vortices 34, 34′ will move the aircraft at increasing speed as rotation of vortices increases. The vortices 34, 34′ will also increase in length as rotation increases.

Referring to FIGS. 7A, 7B, and 7C, descent mode for rotating vortex method of propulsion begins with a descent in altitude. Flight to intended landing site is similar to helicopter maneuver for descent. Stopping directly over intended landing site, rotation is slowed, the slowing in rotation of vortices will rock the craft as it slows. Descent is in vertical mode, FIG. 7C. Ailerons can be used in descent to level aircraft.

Referring, to FIG. 8A, motional movement of an aircraft by using an array of capacitors is shown. In this instance, the capacitors are performing as electrodes, specifically, said large capacitors 701a, 701b, 701cand 701d, within FIG. 8a. Said array could contain more electrodes, in correct arrangements. In FIG. 8A, the single capacitor 701cis indicated as being positively charged, and capacitor 701dand 701b, negatively charged. Capacitor 701adoes not have a charge. Direction of movement will be as indicated by arrow, in this example, in the direction of more highly charged electrodes 701dand 701b.

Referring to FIG. 8B, the capacitor electrodes 701aand 701care indicated as more highly charged than the oppositely charged capacitor electrode 701d. Electrode 701bdoes not have a charge. Movement will be in the direction of more highly charged electrodes as indicated by arrow. The fluctuating direct current utilized by the capacitance system, is a positive factor applying potentials. The capacitors are of a circular configuration. Referring to FIG. 9, a radial plasma tube 64, or gun, for plasma propulsion is shown. The tube entrance for plasma to be accelerated is shown. Eight small capacitors 70a, 70b, 70c, 70d, 70e, 70f, 70gand 70h surround the central shaft 41. Said eight small capacitors are connected in parallel, by said electric system 20. Plasma tube 64 is connected to capacitor 70eat the central shaft end, and large capacitor 701cat exit end 74 of tube 64. The plasma tube, or gun, 64 can be connected to any of the large capacitors 701a, 701b, 701cand 701d or other large capacitors, and also connected to any of the small capacitors 70a, 70b, 70c, 70d, 70e, 70f, 70gor 70h.

Referring to FIG. 10, the aircraft is shown positioned perpendicular with the Earth 76. The electric field 32 of the aircraft is in the direction of the arrow toward the earth. The electric field 32 will interact with the Earth's magnetic field 31 with a strong repulsive force. The high fields of the aircraft will make possible rapid ascent. The only limitation on potential speed will be physical limitations of the crew and structural limitations of the aircraft to withstand resultant g forces. This electric force is the maximum force attainable by our technology. At extremely high speeds in space, which this craft can attain, near speed of light, the magnetic force becomes co-equal with the electric force. In space this aircraft will utilize particle acceleration to attain high speed over time, months to a year. Fuel will be stored in large capacitor plates as plasma. For the aircraft to be utilized as a space or submersible craft, one principle modification is required. The referenced 14 large capacitor plates have to be disengaged from the 56 capacitor plates within the electric system 20, FIG. 4. These 56 capacitor plates are located with and under capacitors 701a, 701b, 701cand 701d, FIG. 4, connected in parallel as opposed to connected in series. Electric wires 801a, 801b, 801c, 801dand 802a, 802b, 802c, 802d, and 803a, 803b, 803c, 803d, and 804a, 804b, 804c, 804d, and 805a, 805b, 805c, 805d, and 806a, 806b, 806c, 806d, and 807a, 807b, 807c, and 807d, FIG. 4, and to include bottom plate wires in each set, said electric wires are located in 14 rows of conducting wires within each quadrant 60a, 60b, 60cand 60d, FIG. 4, bisecting the portion of the electric system 20, shown in FIG. 4. Said rows of electric wires 62, within said quadrants are shown in FIG. 4.

There will be a total of seven rows of four sets of capacitors, for a total 28 sets. Said capacitors will be connected in parallel under the top four capacitors. The capacitance of the 28 sets is equal to the sum of the capacitances of the individual capacitors. The magnetic and electric fields of the seven systems of four capacitors is seven times as great as one system of four capacitors, however, the magnetic field produced has 70 times as much force as one row of four capacitors. The eight small capacitors 70a, 70b, 70c, 70d, 70e., 70fand 70h, FIG. 9, positioned at the interstice between the hulls around support shaft 41, FIG. 9, also adds to the total magnetic force being produced.

After the said 14 large capacitor plates are disengaged from the total of 56 plates, the said 14 plates will be placed in rotation, attached under the blade assembly ring, within the magnetic field of the craft. Fourteen is the preferred embodiment for number of capacitors to be disengaged for rotation. Said procedure will produce plasma as fuel. Said fuel will be stored within the capacitor plates for particle propulsion in space. The disengagement procedure will have to occur four times within the atmosphere, 14 plates each time. For regular flight, all capacitors will be positioned with three rows within the bottom of the top hull 1, and three rows within the top of the bottom hull 1′, FIG. 5. The remaining row of four capacitors will be positioned with the top capacitor plate within and on the bottom of hull 1. The bottom capacitor plates of said row of four plates, will be positioned on the top of bottom hull 1′.

The craft plasma field 34, 34′, will also possess a diamagnetic magnetic field with an electric field. After the ferromagnetism of the craft is lost at high fields, and it becomes paramagnetic only, the magnetic fields of the tungsten, cobalt, zirconium based ring assembly will continue to increase to higher fields, as will the magnetic field of the plasma 34, 34′ . The diamagnetism of a plasma field is not a low magnetic field. The diamagnetism of a metal is a low field, relatively.

The aircraft can immediately be used in space, or as a submersible device, lifting device, or boring device. The underwater propulsion can be accomplished with a known ion propulsion system from the craft magnetic and electric fields at right angles, and both fields at right angles to a Lorentz force directed against the conducting seawater. Blades, FIG. 4, as rotatable propellers can steer or propel the craft underwater. Upon impacting water, hulls can be gravity closed. Upon leaving water, hulls can be gravity opened. Axels will be meshed within a soft material at closing on rims of hulls, or precut half diameter holes will be on rims of hulls. Precut half diameter holes is preferred embodiment. Upon entering gravity free area, hulls will be closed after the blade system has been retracted into craft, and the particle propulsion system will begin operation. Ensuing life support systems will be deployed. In space, the small capacitor system opposed to the large capacitors arrayed at ends of retracted blades, will be used as the particle propulsion system. Tubes inserted in axel holes will direct particles. End of description of the preferred embodiment for aircraft.

Beginning of the operation of the process portion of patent as it relates to a nuclear fusion energy process with said aircraft, said craft now also being called Device or Devices, followed by a description of preferred embodiment for the fusion system.

The fusion energy portion of this patent is a process, more specifically, it is a method for producing electricity from a nuclear fusion reaction without significant radiation produced, or cooling required, using the fuels boron B-11 isotope ion and regular hydrogen.

Referring to FIGS. 5, 11A, 11B, 12A, 12B, 12C, 22D and 12E, depicted are elements of the fusion process utilizing apparatus for an electrolysis system. Said apparatus includes a 50 gallon barrel shaped container for boron B-11 isotope ions 144, FIG. 11B. Said barrel 144 of B-11 isotope ions is connected to tubular column 111g. Laminated glass is preferred embodiment for tubular columns. The B-11 isotope ion tubular column 111g, FIG. 11B, is connected at the other end to ferromagnetic cored column within a larger B-11 isotope ion tubular column 112g. Said ferromagnetic column is connected at the other end to exit electrode 158, FIG. 11B, also called roof electrode. Said B-11 ion will exit roof electrode 158, FIG. 11A at insulated electrode 158, having been placed into mini-Larmor gryro orbit by said ferromagnetic cored column prior to exiting electrode. Said B-11 ion will exit roof electrode with charge indicated by positive sign, (+), under said roof electrode. Direction of movement is indicated by arrows, FIG. 11A. Said particle has been energized while rotating around said ferromagnetic column, and this has not diminished the magnetism of said ferromagnetic column, in fact, it has increased the magnetism of the cored column as well.

Barrel 144, FIGS. 5, 11B and 12D, contains the fusion fuel boron B-11 isotope. Said ion is vaporized out of source prior to electrolysis procedure, at present, and contained within barrel shaped container. The remaining fuel sources will be electrolyzed out of water or seawater. Salt is a catalyst in electrolysis procedures. Maximum current to decompose said solution completely to resulting particles desired, electrons and protons, will be applied on board aircraft. Said water is stored in 50 gallon drum barrels. Platinum electrode is preferred electrode for electrolysis. Said electrolysis apparatus has what appears to be two arms, columns, on each side of individual barrels, except for said B-11 isotope ion, previously prepared. The three remaining barrels, 142a, 142b, and 142c, FIG. 12D, contain H2O, water. Said barrels of water are electrolyzed by electrode 188, FIG. 12D Oppositely charged particles will exit each barrel, positive on one side, negative on opposite side. Though, not on the same side on all barrels. B-11 tube extends straight up.

Sources for boron B-11 isotope includes seawater or borax. Borax is a compound found in nature as tincal. Tincal is available in millions of tons, 200 million in California, a half billion in Turkey, as well as many countries of the world. For the radiation free, and direct conversion to electricity fusion reaction, boron B-11 isotope is required, uniquely. Regular hydrogen, H-1, or H, is also required. The H-1 atom can be obtained from electroysis of water. Said tubular columns are also called tubes.

Of course, no fusion reaction is radiation free, it is conventionally referred to as a radiation free reaction. There is no significant radiation produced, or cooling required, using the fuels boron B-11 isotope and regular hydrogen. Electricity is produced, it can be tapped off onto electrodes.

Barrel 142a, FIGS. 5, 11B, 12D and 12E, contains a solution of H2O, water, for electrolysis by electrode. Said barrel is connected on one side to tubular column 111a. Said column is connected at the other end to ferromagnetic cored column within a column 112a. Said ferromagnetic column is connected at the other end to exit electrode 154, FIGS. 11A and 11B. The positive sign under said electrode 154, indicates exiting electrode is a positively charged particle, in this instance, a proton, p+ or H+ particle or ion, moving in direction indicated by arrows in FIG. 11A. On the other side of said barrel 142a, said barrel is connected to tubular column 111b. Said column 111b is connected at the other end to ferromagnetic cored column within column 112b. Said ferromagnetic column is connected at the other end to exit electrode 160, FIGS. 11A and 11B. The negative sign (−) under said electrode 160, FIG. 11A, indicates exiting particle is a negative particle, an electron, e−, and moving in the direction indicated by arrows, FIG. 11A.

Barrel 142b, containing water for electrolysis by electrode 188, FIG. 12D, is best seen in FIGS. 12D and 12E. In FIG. 12E, on one side of barrel 142b, said barrel is connected to tubular column 111c. Said column is connected at the other end to ferromagnetic cored column 112c. Said ferromagnetic column is connected at the other end to exit electrode 152, FIGS. 11A and 11B. The negative sign (−) under said electrode 152, indicates exiting particle is a negative particle, in this case an electron e−, and moving in direction indicated by arrows, FIG. 11A. Barrel 142b, containing water, is shown in FIGS. 12D and 12E, on the other side of barrel 142b, said barrel is connected to tubular column 111d. Said column is connected at the other end of column 111d to ferromagnetic cored column with a larger column 112d. Said ferromagnetic cored column is connected at the other end to exit electrode 164, FIGS. 11A and 11B. The positive sign (+) indicates said exiting ion is a positive particle, a proton, and moving in direction indicated by arrows in FIG. 11A.

Barrel 142c, containing water for electrolysis by electrode 188, is shown in FIGS. 12D and 12E. On one side of barrel 142c, said barrel is connected to tubular column 111e. Said column 111e, is connected at the other end to ferromagnetic cored column within a larger column 112e. Said ferromagnetic cored column is connected at the other end to exit electrode 156, FIGS. 11A and 11B. The positive sign under said electrode 156, FIG. 11A, indicates said exiting ion is a positive particle, a proton, and moving in the direction as indicated by arrows, FIG. 11A. Said barrel 142c, containing water, is shown in FIGS. 12D and 12E. On the other side of barrel 142c, said barrel is connected to tubular column 111f. Said column 111f is connected at the other end to ferromagnetic cored column 112f. Said ferromagnetic column is connected at the other end to exit electrode 162, FIGS. 11A and 11B. The negative sign (−) under said electrode 162, FIG. 11A, indicates said exiting particle is a negative particle, an electron, and moving in the direction as indicated by arrows, FIG. 11A.

Said electrodes on the roof of aircraft, FIG. 11A, are arrayed alternating from an electrode aperture charged to exit a proton or electron. After exiting electrode, said oppositely charged particles will attract and form H-1 atoms, a fusion fuel. The remaining charged particle, B-11 isotope ion, being positively charged will be repelled by adjacent positive charge, and attracted by adjacent negative charge, forming a higher fuel constituent. Said H-1 atoms have a natural tendency to combine and form H2 molecules. Said H2 molecules, being highly energetic will attract the B-11 positive ions.

Rotational direction of particles on roof of aircraft, FIG. 11A, is the natural rotational direction for particles within or affected by rotational direction of Larmor orbits within a magnetic field. Said particles are in mini-Larmor orbits upon exiting aircraft at roof, FIG. 11A, and are drawn into the naturally forming spherical plasma within the oscillating inhomogeneous particle field.

Required for the fusion process, is the coordinated positioning and functioning of the three separate aircraft described in the field of invention, and in the description of the preferred embodiment for said aircraft. The three craft to be utilized have similar operating systems, the aircraft vary in size and material composition. They are similar but they are not the same. As a different craft, the preferred embodiment for material for the larger craft, Device B and Device C, is magnesium aluminum alloy. The hulls will be magnesium aluminum, the internal structure will be extruded magnesium aluminum alloy. Magnesium is diamagnetic, aluminum has a negligible magnetic susceptibility. Both metals have low melting temperatures. Aluminum is a very good conductor of electricity and can tolerate higher temperatures. The ring assembly preferred embodiment will be the same material as ring assembly on the smaller craft tungsten, cobalt zirconium alloy.

The electric system 20, FIG. 4, is connected to the top and bottom hulls 2, 2′, of said aircraft. As the fluctuating direct current in the three aircraft has an alternating current component, the hulls being attached to the electric systems will alternate in respective charges. This will alternately-utilize one hull as a capacitor charging and one hull will discharge. Magnesium and aluminum have the highest ionization potentials of the metals. The magnesium based hulls will appear to pulsate. The opposing system to the outer hull will be the plasma field with the intervening space as the dielectric. The Langmuir sheath, 36a, 36a′, comparable to an opposite plate. This will also hugely increase the total capacitance of the sum of the individual capacitors.

The larger aircraft bladed ring assemblies, by making contact, touching the hull of highly magnetized ferromagnetic hulled Device A, will be equally highly magnetized with Device A, with no loss of magnetism to Device A. The diamagnetic fields of the large craft, Device B and Device C, are weakly magnetized in comparison to Device A. Bladed rings are equally magnetized.

The bladed ring assembly of Device B and Device C, tungsten, cobalt, zirconium material will also both be equally magnetized with bladed ring assembly of Device A. For the large aircraft to alone raise themselves to high magnetic fields, is preferred option. The plasma field of the craft, obtain energy from the applied magnetic field. The bladed ring assembly of the craft, tungsten, cobalt zirconium alloy could raise the large craft to high fields. The high magnetic field of the ring assembly imparts energy to the applied magnetic field of the craft due to greater efficiency as a conductor at high fields.

The ferromagnetic hulled small craft, Device A, is required for the fusion process. The low melting point of magnesium and aluminum are not indicated for a fusion process. The two billion degrees required for the fusion reaction will produce negligible heat, only electron volt temperatures are involved.

However the exceedingly low melting point of magnesium 651 degrees Celsius, and aluminum, 660 degrees Celsius preclude their use. Pyramid shaped cone is preferred embodiment.

Magnesium is one of the strongest metals for aircraft, it is exceeded only by titanium. Magnesium has an added benefit of being light in weight, as is aluminum.

Spherical plasma can be formed on the roof of magnesium hulled craft for operating energy, or to apply pressure from opposite sides toward the central fusion spherical plasma on the roof of the ferromagnetic hulled smaller craft. As the non-fusion spherical plasmas are comprised of orbiting charged particles, electricity, they are a potential source of operating energy for the aircraft. It is my opinion the spherical plasmas will persist.

A cone shaped pyramidal column 167, FIG. 11B, is located centered on roof of the smaller aircraft prior to beginning the fusion process. A glass ball electrode 169, FIG. 11B, preferred electrode embodiment for pyramidal cone, is situated on top of the pyramidal shaped column 167. The ball electrode is slotted and air cooled. Raising the pyramidal cone with the ball electrode on top will induce an induced magnetic field on the roof of said smaller aircraft. By positioning two similar in operation, but larger in size aircraft on each side of the horizontal smaller aircraft A, A′, and perpendicular to the smaller aircraft, the fusion process can proceed. The positioning of the aircraft is required to obtain the pressure and temperature required for ignition of spherical plasma 170, FIG. 11B.

The larger aircraft on left side of horizontal aircraft A, A′, is perpendicular aircraft B, B′, FIG. 12A. The larger craft on the right of horizontal aircraft A, A′ is perpendicular aircraft C, C′, FIG. 12A. The larger aircraft will have spherical plasmas on the roofs of said aircraft, as well, only they are non-B-11 ion spherical plasmas. They will not contain the Boron B-11 isotope. Spherical plasma 174, FIG. 12A is on the roof of aircraft B, B′. Spherical plasma 178, FIG. 12A is on the roof of aircraft C, C′. The fusion spherical plasma is on the roof of aircraft A, A′. Spherical plasma 170 contains the fusion fuel Boron B-11 isotope. Regular hydrogen atom, H-1, or H is contained within the fusion spherical plasma as well as within the non-B-11 spherical plasmas. A11 the referenced spherical plasmas are by electrolysis.

By positining the larger aircraft perpendicular to smaller horizontal aircraft A, A′, the two larger aircraft have placed their spherical plasmas on top of the roof of the smaller aircraft A, A′. Spherical plasma 178 and 174 now abut the fusion spherical plasma 170 from opposite sides. The fusion spherical plasma 170 is also within the tightening smaller induced Larmor orbiting particle field 182, FIG. 12A. There also exists an induced electric field 186, FIG. 12A. Said field contributes to temperatures required for ignition of fusion spherical plasma, and can be assumed to be receiving energy from emitted electromagnetic radiation from ball electrode 169, FIG. 11B.

The electromagnetic radiation 44, 44′, FIG. 5, emanates from the induction coil 47, 47, FIG. 5, part of the aircraft oscillatory circuit. The pyramidal cone shaped column is placed over circular opening remaining after removal of hatch cover 23a. The ball electrode 169, FIG. 12A, is placed on top of said pyramidal cone. In normal operation, an electrode is on top of induction coil 47, FIG. 5, with a bottom electrode over bottom coil, 47′, top electrode 169, FIG. 12A, bottom electrode 169 ′.

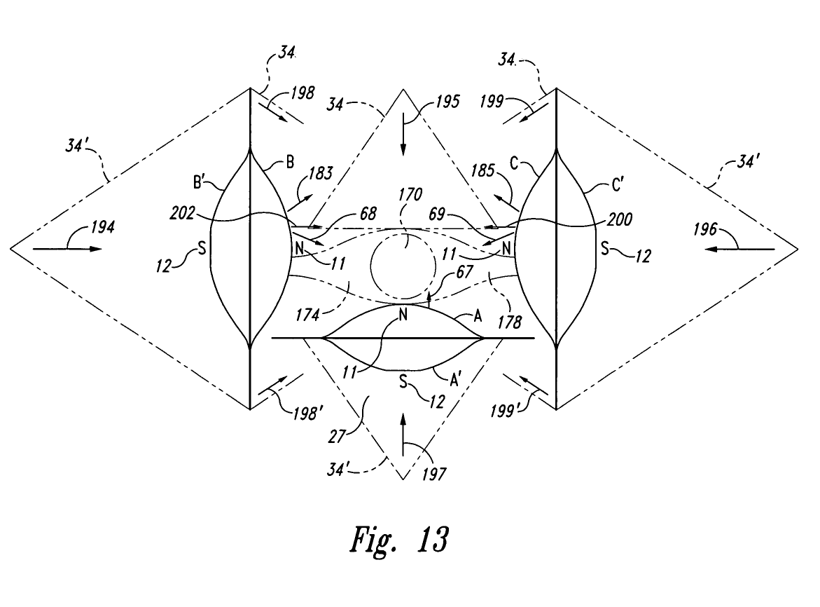

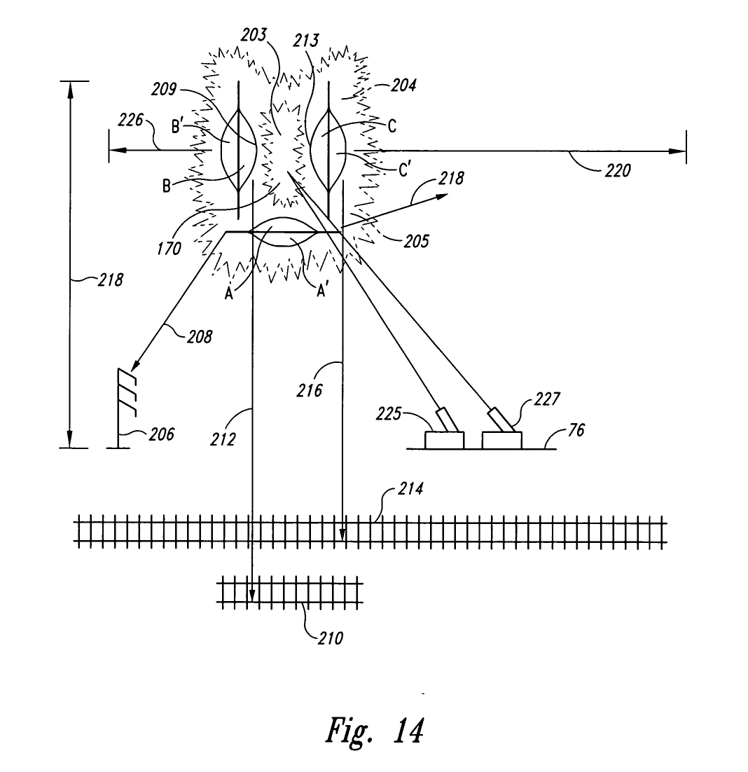

The bottom rotating plasma vortex 34′ of aircraft B, B′ and the bottom rotating plasma vortex 34′ of aircraft C, C′ by increasing thir rotational rate are applying pressure from both sides to fusion spherical plasma 170 on the horizontal roof of Device A. The rotational direction of plasma 174 is perpendicular to rotational direction of fusion spherical plasma 170, and is in the opposite direction to rotational direction of spherical plasma 178 of aircraft C. These opposing rotational directions added to the pressure from the rotating vortices squeezing the spherical plasma 174 and 178 into fusion spherical 170, comprise part of the increased pressure and temperature. The tightening induced Larmor orbiting particle field is enveloping the spherical plasmas, the induced electric current, and adding the considerable number of orbiting charged particles within the induced Larmor field, said Larmor field being comprised of charged particles itself, to the fusion spherical plasma. The rotating spherical plasmas 174 and 178, FIG. 12B have been squeezed into an amorphous mass around fusion spherical plasma 170, best seen in FIG. 13. At the same time, magnetic fields 49a and 49b, FIG. 5 around the bladed ring assembly 2, 2′, FIGS. 2 and 3, on each aircraft are concentrating the three magnetic fluxes all intersecting, with resultant increase in temperature. Heat is still being added from significant, multiple sources. Rotating vortices of Device C and B, 34′, FIG. 13, are still increasing pressure. There are other pressure and heat sources, the bottom vortex 34′ of aircraft A, is pushing against repulsive magnetic forces 202, 67 and 69 from opposing North Poles 202 and 206, FIG. 13 of the three aircraft.

The time is opportune for ignition by land based neutral beam 225, FIG. 14, or high power laser 227, FIG. 14. At the moment of ignition of fusion spherical plasma 170, there will be an appearance of flames, though it is primarily photon energy, rather than heat. The aircraft will be grounded by ground cables, Device A to hi-tension pole by cable 208, Device B to railroad track 210 by cable 212, Device C to railroad track 214 by cable 216. Hi-tension wire pole 206, FIG. 14, is positioned to the left of said large devices. Craft C will be blown and move itself to the right 120 feet, aircraft B will be blown and move itself to the left 30 feet, aircraft A will be blown and move itself 100 feet to the right behind plasma cloud.

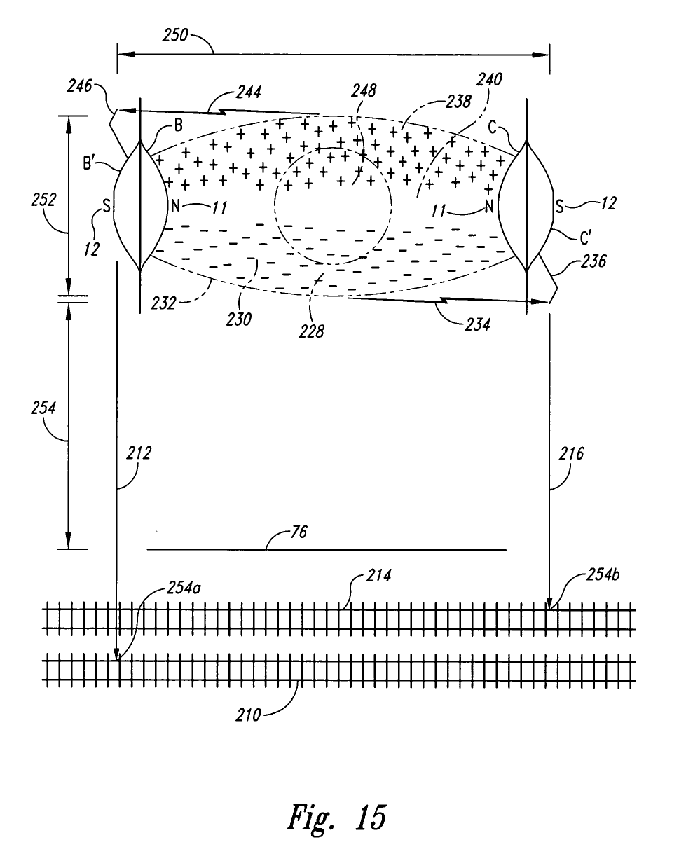

The end phase is shown in FIG. 15. The energetic charged particles created in the nuclear fusion reaction are positioned between the two large aircraft. A failed attempt at organizing in the center 248, FIG. 15, of the plasma cloud leads to a collapse of the plasma formation, and what ensues is similar to atmospheric phenomenon when a storm cloud collapses and lightning is produced. The two large aircraft, Device B and Device C, collect the huge bolts, in effect, lightning bolts of different charge. A green bolt of positive electricity to one craft, a blue, white, red bolt of negative electricity going to the other craft with outstretched, extended collecting rods on opposite ends of each craft. The energy can be stored within craft magnetic fields, stored in an on-board superconducting ring, or transferred to a power distribution center by microwave. If an on-board superconducting ring is utilized, energy to reduce temperatures to permit superconductivity, will not be a factor. At the present time, size is a factor, though not insurmountable.

End of the operation of process portion of this-patent.

Beginning of description of the preferred embodiment for the process portion of this patent relating to a nuclear fusion reaction process or method for producing electricity from a nuclear fusion reaction without significant radiation produced, or cooling required, using the fusion fuels B-11 isotope ion and regular hydrogen atom. The “11” in B-11 isotope is the “neutrons”, and, as all boron has five protons, the correct designation for this isotope would be ₅¹¹boron, or ¹¹boron. Conventionally, it is called B-11 isotope, or B-11. The hydrogen atom is one proton and one electron. The correct designation is ₁¹H, or H. Conventionally, H is referred to as H-1. The ion H+, a proton, is also the hydrogen atom, H-2, without an electron. The terms B-11, H-1, and H+ will be utilized.

Referring to FIG. 11A, a top perspective view of the top, roof surface of Device A, is shown. Insulated exit electrode aperatures are also shown. Electrode 156 is designated as positive by the indicated sign (+) below said electrode., Electrode 156 is in reality negative, the exiting particle is designated by the charge sign. In the instant case, the particle exiting electrode 256 is a positive proton, a positive sign is indicated. Moving counterclockwise, for the next electrode, electrode 152, a negative electron is shown. The next electrode, electrode 154, a positive proton is shown. The next electrode 158, B-11 isotope ion is shown as positive. The next electrode, electrode 160, a negative electron is shown. The next electrode 164, a positive proton is shown. The next electrode 162, a negative electron is shown. In the center of said top surface of Device A, a dashed line circular opening, 23a, represents area to be covered by the raised pyramidal cone 267, after hatch cover 23a, FIG. 5, is removed. Ball electrode 169 is placed on top of said pyramidal cone prior to raising cone over opening 23a.

Arrows shown in FIG. 11A represent rotational direction of said particles after exiting tubular columns onto said roof. The particles will be rotating in the direction of said arrows when exiting said aperatures. Said direction is to the right when viewed from the bottom of craft, hypothetically, or moving counterclockwise when viewed from above the craft, looking down.

Referring to FIG. 11B, a cross section side view of Device A is shown. A fifty gallon drum barrel shaped container of prepared B-11 isotope ion 144, is shown. Said barrel shaped container is attached to a B-11 isotope tubular column 111g. Said column 111g is attached at the other end to a ferromagnetic cored column within a larger tubular column 112g. Preferred embodiment for the bottom tubular columns is translucent shock and fracture resistant glass and also for ferromagnetic columns, same glass is fracture and shock resistant. Said column 112g, is connected at the higher end to exit electrode 158. The remaining columns depicted in FIG. 11B, are connected at the bottom of the smaller bottom tubular column to 50 gallon drum barrels of water, H2O solution, best seen in FIG. 12D. Referring to FIG. 11B, said barrels of water are located behind barrel 144. The bottom of column 111a, FIG. 11B, is connected to barrel 142a, FIG. 12D, for electrolysis by electrode 188, FIG. 12D. The other end of said column 111a, FIG. 11B, is connected to ferromagnetic cored column, within a larger tubular column 112a, FIG. 11B.

Said column 112a is connected at the other end to exit electrode 254. The particle emanating from electrode 154 is a positive particle, a proton, FIG. 11A. Tubular column 111b is connected to said barrel 142a, FIG. 12E, on the other side of said barrel. Tubular column 111b, FIG. 22B, is connected at the other end to ferromagnetic cored column, within a larger tubular column 112b, FIG. 11B. Said ferromagnetic cored column 112bis connected at the other end to exit electrode 260, FIG. 11A. The particle emanating from electrode aperture 260 is a negative particle, an electron.

The bottom of tubular column 111c, FIG. 22B, is connected to barrel 142b, FIG. 12D, for electrolysis by electroode 188, FIG. 12D. The other end of said column 111c is connected to ferromagnetic cored column, within a larger tubular column 112c. Said ferromagnetic column 112c is connected at a higher end to exit electrode 152, FIG. 11A. The particle emanating from said electrode opening, a negative particle, an electron, is shown in FIG. 11A. On the other side of said barrel 142b, column 111d is connected to said barrel. The other end of said column 111d is connected to ferromagnetic cored column, within a larger tubular column 112d. Said ferromagnetic column is connected at a higher end to exit electrode 164, FIG. 11A. The particle emanating from said electrode is a positive particle, a proton.

Shown in FIG. 11B, the bottom of column 111e is connected to barrel 142c, FIG. 12D, for electrolysis by electrode 188, FIG. 12D.

The other end of said column 111e is connected to ferromagnetic cored column, within a larger tubular column 112e. Said ferromagnetic column 112e is connected at a higher end to exit electrode 156, FIG. 11A. The particle emananting from electrode 156 is a positive particle, a proton. On the other side of said barrel 142c, FIG. 12E, tubular column 111f is connected to said barrel 142c. The other end of said column 111f is connected to ferromagnetic cored column, within a larger tubular column 112f. Said ferromagnetic column 112f is connected at the other end to exit electrode 162, FIG. 11A. The particle emanating from said electrode 162 is a negative particle, an electron.

The particle emanating from exit electrode 158, a positive ion, originates from barrel 144 containing said B-11 isotope ion.

Referring to FIG. 12A, upper portion of said diagram, shown is a side view of the small Device A, positioned horizontal. On the left side of said small device, is large Device B, positioned perpendicular to small Device A. On the right side of small Devive A, is large Device C, positioned perpendicular to small Device A. Shown on all three devices are north and south pole signs, N and S. Fusion spherical plasma 170 is shown positioned on top of Device A. Non-fusion spherical plasma 174 is shown on the roof of Device B. Non-fusion spherical plasma 178 is shown on the roof of Device C. On each side of fusion spherical plasma 170, is depicted induced Larmor gyro orbiting particle field 182.

Said induced plasma field is indicated on only one side 182, as it is a circular field around fusion spherical plasma 170. Said Larmor orbiting plasma particle field, is increasingly applying circular, tightening pressure, to said fusion spherical plasma 170. Centered within said fusion plasma 170 is a raised pyramidal column 167. Positioned on top of said pyramidal cone is ball electrode 169, a heat resistant glass ball, with slotted apertures. Said pyramidal cone is an extension of the underlying electric coil, also called induction coil, 47, 47′, FIG. 5.

Raising said pyramidal cone, induced a magnetic field. Within said induced magnetic field is said induced Larmor particle field. Also present is an induced electric field 186, FIG. 12A. Said induced electric field could possess concentration of energetic charged particles at the mid-point of said induced electric field. In effect, an induced electric current, though there is not a conducting element present, if there were, said conductor would be a powerful conducting element. Non-fusion spherical plasmas can be mined by passing a conducting circuit through this area. Or, a multitude of said circuits. It is conceivable that said spherical plasmas will persist. Said induced electric current will be at the center line 186, FIG. 12A, through the electric field 186, FIG. 12A.

Said non-fusion spherical plasmas are shown on each side of fusion spherical plasma 170. Said non-fusion spherical plasma 174, FIG. 12A, applys pressure from the left side. Said non-fusion spherical plasma 178 applys pressure from the right side to fusion spherical plasma 170 in the middle. Vortex 34′, Device B, and vortex 34′, Device C, are applying rotational propulsion pressure toward said fusion spherical plasma 170, from both sides.

Referring to FIG. 12A, lower diagram. Said lower diagram is identical to FIG. 11B. Said lower diagram, FIG. 12A, is located below upper diagram 12A to provide a frame of reference to identify the central, horizontal figure, Device A, within upper diagram, FIG. 12A, by means of the common pyramidal cone 167. Said reference point, the pyramidal cone, is the sole reason for said lower diagram in FIG. 12A. Said abstract upper diagram in FIG. 12A, is able to be comprehended as an aircraft by this common point of reference. Other shape column or electrode can be used.

Referring to FIG. 12B, the rotational directions of the three spherical plasmas, 174, 170 and 178 are shown. Viewing the three spherical plasmas from the center plasma 170. The left spherical plasma 174 is rotating in the opposite direction to spherical plasma 178 and rotating perpendicular to fusion spherical plasma 170. The three spherical plasmas are rotating in different directions. Said varying rotational directions are a contributing factor toward the increasing temperature required for ignition. Additionally, spherical plasma 174 and 178 are being pressed into the fusion spherical plasma 170, from both sides, by propulsion directions of Device B and Device C as represented by arrows 196 and 194, FIG. 13.

Referring to FIG. 12C, the top of the induced Larmor orbiting plasma particle field 184, is shown from the top. A side view of said Larmor field 182 is shown in FIG. 12A, upper diagram as side view 182 of top view, 184, shown in FIG. 12C. Fusion spherical plasma 170, FIG. 12A, is completely encircled by the tightening induced Larmor particle field at this stage. Said Larmor field will also be absorbed by said fusion spherical plasma 170.

Referring to FIG. 12D, shown is a top view of the 50 gallon drum barrels 142a, 142b, and 142c, of water for electrolysis procedure. Said electrolysis procedure involving said barrels is located on the bottom deck 96′, FIG. 5. Also shown is the 50 gallon barrel shaped container of previously evaporated B-11 isotope ions 144, FIG. 5. Shown within barrels for electrolysis of water are electrodes to be utilized in electrolysis procedure, electrodes 188. In the middle of said barrels, between barrel 142a and barrel 142b, is central shaft 41′, FIG. 5. Bottom octogonal shaped interior wall structure 8′, is shown.

Referring to FIG. 12E, shown is best view of electrolysis system described in comprehensive detail. In FIG. 12E, depicted is complete view of said barrels 142a, 142b, 142c and 144, attached to indicated columns, providing a complete view of said overall electrolyis system. Said apparatus for electrolysis includes said fifty gallon drum barrel shaped container of prepared B-11 isotope ion 144. Said barrel is attached to B-11 isotope ion tubular column 111g. Said column 112g is attached at the other end to a ferromagnetic cored column within a larger tubular column 112g. Preferred embodiment for said column is translucent laminated glass. Said glass is fracture and shock resistant, in preferred embodiment. Said column 112g is connected at the higher end to exit electrode 158, FIG. 11A. The remaining barrels depicted in FIG. 12E utilize water, H2O, as fuel for electrolysis. Barrel 144, alone, utilizes boron B-11 isotope ion, previously vaporized out of source. Said source being seawater or borax from tincal. Borax is preferred fuel source. Other sources are available as well. Barrel shaped container is preferred embodiment.

The bottom of column 111a, FIG. 12E, is connected to barrel 142a for electrolysis by electrode 188, FIG. 12D. The other end of said column 111a, is connected to ferromagnetic cored column, within a larger tubular column 112a. Said column 112ais connected at the other end to exit electrode 154. The particle emanating from electrode 154 is a positive particle, a proton, FIG. 11A. Tubular column 111b is connected to said barrel 142a, FIG. 12E, on the other side of said barrel. Tubular column 111b is connected at the other end to ferromagnetic cored column, within a larger tubular column 112b. Said ferromagnetic cored column 112b is connected at the other end to exit electrode 160, FIG. 11A. The particle emanating from electrode aperture 160 is a negative particle, an electron.

The bottom of tubular column 111c, FIG. 12E, is connected to barrel 142b for electrolysis by electrode 188, FIG. 12D. The other end of said column 111c is connected to ferromagnetic cored column, within a larger tubular column 112c. Said ferromagnetic column 112c is connected at a higher end to exit electrode 152, FIG. 11A. The particle emanating from said electrode opening, is a negative particle, an electron. On the other side of said barrel 142b, column 111d is connected to said barrel. The other end of said column 111d is connected to ferromagnetic cored column, within a larger tubular column 112d. Said ferromagnetic column is connected at a higher end to exit electrode 164, FIG. 11A. The particle emanating from said electrode is a positive particle, a positive proton.

The bottom of column 111e is connected to barrel 142c, FIG. 12E for electrolysis by electrode 188, FIG. 12D. The other end of said column 111e is connected to ferromagnetic cored column, within a larger tubular column 112e. Said ferromagnetic column 112e, is connected at a higher end to exit electrode 156, FIG. 11A. The particle emanating from electrode 156 is a positive particle a positive proton. On the other side of said barrel 142c, FIG. 12E, tubular column 111f is connected to said barrel 142c. The other end of said column 111f is connected to ferromagnetic cored column, within a larger tubular column 112f. Said ferromagnetic cored column 112f is connected at the other end to exit electrode 162, FIG. 11A. The particle emanating from said electrode 162 is a negative particle, an electron. Referring to FIG. 13, a side view of Device A, Device B, and Device C, is shown. Aircraft B, also called Device B, is positioned perpendicular to horizontal Device A, and is located to the left of Device A. Device C is perpendicular to Device A, and is located on the right of Device A. Device A is horizontal to earth. The fusion spherical plasma 170 on top of Device A, is now surrounded by an amorphous mass consisting of spherical plasma 174 and 178. The rotational energy of Device B bottom vortex 34′, is directed toward spherical plasma 170 as indicated by arrow 194. The rotational energy of Device C bottom vortex 34′, is directed at spherical plasma 170 as indicated by arrow 196. The rotational energy and pressure of Device A bottom vortex 34′, is directed at spherical plasma 170, the fusion plasma, by arrow 197, and is also directed against opposing repulsive magnetic north pole 68 of Device B, and repulsive north pole 69 of Device C, by the repulsive north pole force 67 of Device A.

Remnant organizing rotational force directed toward the fusion spherical plasma 170 from Device B top vortex 34, is represented by arrow 198, and from Device C top vortex 34, represented by arrow 199, and from Device B, top vortex 34, represented by arrow 198′, and from Device C top vortex 34, represented by arrow 199′. Plasma propulsion 27 can be used to augment lesser rotational force of Device A vortex 34′, as compared to Device B and Device C. Repulsive magnetic north pole force 202 from top of Device B is directed as indicated by arrow 183. Repulsive magnetic north pole force 200 from Device C is directed as indicated by arrow 185.

The most notable event of all in on-going fusion process is the absorption of induced Larmor gyro orbiting particle field 182 into fusion spherical plasma 170. The Larmor orbiting particle field 182 was composed of rotating highly energetic particles increasing in energy to the speed of light. This energy has now been added to the equally energetic rotating particles within the fusion spherical plasma 170.

Incrementally, the process is approaching a two billion degree temperature needed for ignition with the fusion fuels Boron B-11 isotope and regular hydrogen. Depicted In FIG. 13 is the absorption of induced electric field 186 FIG. 12A by the fusion spher-plasma 170. Within a short period of time, the amorphous mass encircling fusion spherical plasma 170 will also be compressed into spherical plasma 170. The amorphous mass, spherical plasma 174 and spherical plasma 178, contains considerable energy. The aircraft are accompanied by a circular magnetic field around the bladed ring assembly 2, 2′, FIG. 5, of each device. The intersecting magnetic rings of each device, will concentrate their magnetic flux with a resultant increase in temperature, and increase in temperature of the fusion spherical plasma.

Referring to FIG. 14, at the moment of ignition, around the fusion spherical plasma 170, FIG. 12A, there will be an appearance of flames 204, though it is primarily photon radiation. Photon radiation is relatively harmless. A large quantity of energetic particles are being created by the fusion reaction. The horizontal Device A, FIG. 12A, will ground itself to high-tension power line 206 by cable 208. The large perpendicular Device B, with an opposing north pole 209 facing north pole 213 of Device C, will ground itself to railroad track 210 by cable 212. Large perpendicular Device C will ground itself to railroad track 214 by cable 216. The three devices, A, B and C are approximately 110 feet 218, FIG. 14, above the Earth 76. At the moment of ignition, the smaller aircraft, Device A, will be moved, as well as move itself, 100 feet in the direction 218 behind the developing plasma cloud 232, FIG. 15. Prior to ignition, the three devices, A, B and C will be close together, almost contiguous. The perpendicular aircraft, Device C will be blown and move itself 120 feet to the right as represented by arrow 220. The perpendicular aircraft, Device B, on the left, will be blown and move itself 30 feet to the left as represented by arrow 226. If necessary, ignition can be accomplished with land based high power laser 227, or the more potent land-based neutral beam 225.

Referring to FIG. 15, the end phase of nuclear fusion reaction is shown. Negative ions and particles 228, FIG. 15, attracted to positive charged Earth 76, collect on the bottom of plasma cloud 230. After the plasma cloud breaks down in a failed attempt to organize spherically in the center of plasma cloud 230, as indicated by weakly organizing sphere 248, in the center of plasma cloud 230, the energetic particles slow in their failed attempt to organize into a spherical plasma. The plasma collapses due to insufficient energy to maintain its organizing effort. The plasma cloud formative energy comes from the magnetic fields of Device B and C, and from the fusion reaction energy which diminishes with growth of the organizing effort by forming spherical plasma 248. Intentional control of Device B and C magnetic fields can also hasten, or terminate growth of the central organizing spherical plasma 248. Negative ions and particles 228, FIG. 15, attracted to positive charged Earth 76, collect on the bottom of plasma cloud 230. On the top of plasma cloud 230, FIG. 15, positive ions and particles 238 collect, having been repelled by assumably positive charged Earth 76. The Langmuir sheath 232, envelopes the entire plasma.

There is a space 240, FIG. 15, between negative and positive charges. The positive charges being repelled by positive Earth, the negative charges being equally attracted by Earth and positive charges above. The approximate width of the cloud is 150 feet, 250, FIG. 15. It is a plasma cloud, composed of positive and negative ions. After breakdown of organizing plasma 248, a bolt of green electricity as represented by pointed arrow 244 will strike extended, pointed rod 246, extending out from top of Device B. An equally large bolt of red, with white and blue electricity 234 will strike pointed rod 236, extending out from Device C. Electricity can be stored within craft magnetic field, the capacitance system or the induction system, or said electricity can be transferred to land-based superconducting ring by microwave transmission. Energy not being a factor, a superconducting ring on-board the craft is feasible. The cooling factor is resolved by the abudance of available energy, the critical temperatures for superconducutivity can be met. The large size of supporting apparatus can easily be resolved.

The height of plasma formation above ground 254, FIG. 15, will be approximately 70 to 80 feet, as shown in FIG. 15. The North Pole 11, is shown for both perpendicular Device B, and perpendicular Device C. Ground cable 216 from Device C on right connects to railroad track 214. A remote magnetic release disengages ground cable connection 254b. A grounding device 212 from Device B on left is connected to railroad track 210. A remote magnetic release 254a, disengages ground cable 212 from railroad track 210, FIG. 15.

The horizontal Device A has been located behind the opaque plasma cloud, approximately 100 feet from fusion reaction location.

In magnetohydrodynamic theory, said aircraft plasmas are able to store all the fusion energy produced, as plasmas are believed to be a fluid able to transmit electricity with infinite capacity to store said electricity.

1. A multi-function aircraft comprising a ferromagnetic body hull, an annular ring of blades arrayed around a peripherical midsection of said aircraft, said array of blades also called ailerons, before said blades are wrapped by uninsulated field windings, said blades are called blade cores, said field windings are connected by conducting wires to an array of capacitors located within the body hull of said airacraft, free ions are produced on said current carrying field winding surfaces on a bladed ring assembly arrayed around central periphery of said craft, by means of receiving an electric charge from said uninsulated blade surfaces, ions are thereby energized and then warped into a Lorentz angle at right angles to said craft magnetic and electric fields and then into perpendicular Larmor orbiting particle fields around said aircraft, perpendicular Larmor fields within applied magnetic field of said aircraft,
forming funnel shaped plasma vortices above-said annular bladed ring, and below said bladed ring within aircraft applied magnetic field, said applied magnetic field formed upon starting aircraft operation from remnant magnetism within said aircraft and by the craft oscillatory circuit, said bladed ring assembly around said aircraft is also called a bladed ring, said aircraft body hull having been magnetized by said gyro-orbiting particle fields around said aircraft, rotational direction for both vortices by the right hand rule, motional direction is up, said aircraft will lift off the earth and become airborne,
said aircraft magnetic field will be raised to high fields, said Larmor orbiting particles are, in effect, the electric coil, an electromagnet, said ferromagnetic craft is the magnetic core inside the electromagnet, the Larmor orbiting particle fields are increasing in speed to the speed of light, at the same time, the aircraft is being raised to high fields, said high fields translate into high electric fields, a huge amount of electrical energy will be produced by the high magnetic and electric fields, said energy can be stored in the array of capacitors within said aircraft, and within the craft inductance coil, and within the craft orbiting particle fields, said Larmor orbiting particle fields are diamagnetic, said field windings are uninsulated conducting field windings, said aircraft has a fluctuating direct current with an alternating current component within an oscillatory circuit possessing an inductance coil and an array of capacitors, Said craft has few moving parts except for a plurality of axels pivotally connected to said blades, and at the other end of said axels, said axels are connected to an interior blade attachment ring, said high electric and magnetic fields combined with said rotating plasma vortices, will lift said craft off the earth,
said aircraft possesses a means for navigation, to include the most advanced flight control systems used by conventional aircraft, additionally, said aircraft possesses a navigation and control system that operates faster than conventional aircraft, said claimed navigation system utilizes ailerons operating in a different environment than ailerons on a conventional aircraft, a plurality of smaller capacitors arrayed around (a) said aircraft central shaft, said Larmor plasma fields, also called Larmor orbiting particle fields, possess Langmuir sheaths to the extent of the Debye length on both the exterior surface of said Larmor plasmas, and on the interior surface of said Larmor plasma fields, on the exterior plasma surface 34, 34′, FIG. 1, and on the interior plasma exterior surface nearer to the hull, 34a, 34a′, FIG. 1, of said Larmor particle fields, said width of said plasma fields between 34 and 34a, and 34′ and 34a′, is the width of the length of a blade in said bladed ring assembly, between 34 exterior surface and 34a interior surface is the width of the length of a blade in said blade assembly ring, said interior plasma surface 34a, 34a′, FIG. 1, to the surface of the hulls 1, 1′, FIG. 1, of said aircraft, is a vacuum area, said vacuum area includes area between said hulls to include said array of capacitors, enabling said capacitors to operate with said vacuum as a dielectric, and said vacuum also permitting formation of fusion spherical plasma on roof of said aircraft, in said vacuum area,
a means of propulsion by use of said rotating plasma vortices, a means of propulsion by use of said capacitors as electrodes with movement of aircraft toward the electrode or electrodes most highly charged, a means of propulsion by means of a plasma gun, also called plasma tube, within said aircraft, a means of propulsion by positioning electric field of craft at right angles to said earth magnetic field, some of said propulsion systems, though widely known, were not heretofore feasible, but are now possible due to high field conditions attained by said aircraft,
propulsion by means of particle propulsion in space, propulsion underwater by means of a known ion propulsion system interacting with said conducting water with a Lorentz force, said Lorentz force being at right angles to craft magnetic and electric fields, said propulsion systems include navigation systems utilizing directional control of said propulsion systems, or a secondary navigational or propulsion system, ailerons utilized as propellers for navigation or for propulsion, or a combination thereof underwater, in atmosphere plasma propulsion can be used, movement with capacitors, a vortex mode of propulsion, all combinations of propulsion and navigation systems cited, are claimed, use of said aircraft as a lifting device, or as a boring device,
a method of charging said capacitor plates with plasma for particle propulsion in space by means of rotating said disengaged capacitor plates beneath said annular ring of said aircraft, said bladed ring assembly encircling said aircraft is also called an annular ring, whereby said plates will absorb and store said plasma for particle propulsion in space, a system to create an artificial atmosphere by means of utilizing electrolysis, a means of navigation underwater by use of said blades as rotating propellers, or as an alternate means for propulsion, nozzles to extinguish incipient combustion, or fire, on said blades, use of said aircraft for verticle take-off and landing, a means whereby said aircraft are rendered invisible to visible and electromagnetic radiation,
a means of viewing through said opaque plasma, at magnetic pole where light is polarized by use of an antenna on roof of said aircraft, and trailing wire beneath, capability of said aircraft to be used within radiation belts above the earth, the ionosphere and the magnetosphere, not otherwise safe to enter, capability of said aircraft to remain in said radiation belts for extended periods of time, capability of said aircraft to operate within outer space, to reach space utilizing the same fuel, water, and systems utilized on earth, and upon reaching outer space to utilize a particle propulsion system.

2. The aircraft as defined in claim 1, wherein hull of said smaller aircraft is comprised of the material chromium steel.

3. The aircraft as defined in claim 1, wherein said array of capacitors are comprised of the material aluminum.

4. The aircraft as defined in cliam 1, wherein said inductance coil is comprised of thick coils.

5. The aircraft as defined in claim 1, wherein said plurality of blades in said bladed ring assembly, comprises approximately 32 blades.

6. The aircraft as defined in claim 1, wherein said blade cores are comprised of the materials cobalt, tungsten, zirconium.

7. The aircraft as defined in claim 1, wherein said blade field windings are comprised of the material tungsten.

8. The aircraft as defined in claim 1, wherein said plurality of capacitors consists of approximately 28 large capacitors and eight small capacitors, said 28 large capacitors comprise 56 large capacitor plates, and said eight small capacitors comprise 16 small capacitor Plates.

9. The aircraft as defined in claim 1, wherein said capacitors will be connected in parallel.

10. The aircraft as defined in claim 1, wherein said means for navigation in the atmosphere will comprise said conducting ailerons operating by reacting against a field of highly charged orbiting particles.

11. The aircraft as defined in claim 1, wherein said capacitors utilize titanium dioxide compound as a dielectric.

12. An electrolysis system, in preferred embodiment located within said comprising water in barrel shaped containers of previously vaporized in preferred embodiment, boron B-11 isotope ions, electrodes to electrolyze said water, a means to convey said ions to larger tubular columns, said means being smaller hollow tubular columns, a means to convey said ions to roof electrode exits in spirals around interior ferromagnetic cores within said larger columns, wherein said funnel-shaped spirals will coalesce into a fusion spherical plasma within an induced magnetic field, within a vacuum area on roof of said aircraft, said spirals collapsing due to loss of rotational energy imparted to spirals within said larger columns, said spirals will coalesce into said fusion spherical plasma upon exiting onto roof of said aircraft, said ions rotating around said ferromagnetic columns increasingtly magnetize said ferromagnetic columns, and accelerate said energetic charged particles, and upon exiting onto roof, said particles are in temporary, funnel-shaped spirals.

13. The aircraft as defined in claim 12, wherein said electrode on roof of said aircraft, is raised by means of raising a pyramid shaped, columnar cone with said slotted, air-cooled, glass ball roof electrode on top of said columnar cone.

14. The aircraft as defined in claim 12, wherein said means for conveying said ions to a larger tubular column comprises use of translucent, shock and fracture resistant, laminated glass tubular columns.

15. The aircraft as defined in claim 12, wherein said electrolyzing electrode is comprised of the material platinum.

16. The aircraft as defined in claim 12, wherein said means for accelerating said particles, is comprised of ions rotating around a ferromagnetic core, within a large columnar tube.

17. A nuclear fusion reaction process utilizing said smaller ferromagnetic aircraft, and two larger magnesium aluminum aircraft to produce ignition of a formed fusion spherical plasma to produce energetic charged particles which can be tapped off onto electrodes as electricity, or other method, comprising the means, or method, of positioning said two larger aircraft perpendicular to said smaller horizontal aircraft relative to earth 76, FIG. 14, and by utilizing the intersecting aircraft, top, different direction rotating, plasma funnels FIG. 12A, top diagram, on each of the three aircraft, said three, formed spherical plasmas, one being a fusion spherical (plasma,) plasma also being (utilized,) utilized FIG. 12A, upper diagram, and by utilizing said formed, induced magnetic field, induced Larmor orbiting particle field, and induced electric field, requisite pressure and temperatures needed will be approached, said induced electric field 186, FIG. 12A, upper diagram, is centered within the conducting plasma of said fusion spherical plasma 170, FIG. 12A, upper diagram, said induced Larmor orbiting particle field 182, FIG. 12A, upper diagram, is located around said center fusion spherical plasma 170, FIG. 12A, upper diagram, shown is a view of said Larmor induced orbiting particle field 182 from the side,
narrowing and tightening over time, around said fusion spherical plasma, the Larmor orbits narrow as the charged particles forming said induced Larmor field narrow as energy increases to the speed of light, shown in FIG. 12C is the induced Larmor orbiting particle field 184, in a view from the top, looking down, large magnesium aluminum aircraft have to be used after ignition of said fusion spherical plasma, as said smaller ferromagnetic aircraft will lose its ferromagnetic magnetism at the high fields that will be reached after ignition of said fusion spherical plasma, said induced fields formed by means of raising said pyramid shaped columnar cone 167, FIG. 12A, said raised cone possessing a slotted, air-cooled, glass ball electrode on top of said pyramid shaped cone, and said glass ball electrode, in effect, now raised from its original position as the aircraft magnetic north pole electrode, inducing said fields, or said ball electrode is expanding said applied magnetic field with essentially the same effects and results as inducing said fields, said electrolyzed and contained particles from completely decomposed water, ions,
and from boron B-11 isotope ions vaporized from source previously, said fusion spherical plasma having now been formed 170, FIG. 12A, upper diagram, and by means of increasing energy, and increasing rotation of bottom vortices of said larger aircraft, pressure will be applied to said fusion spherical plasma from both sides, said spherical plasma is being prepared for ignition, said larger aircraft also possessing non-fusion spherical plasmas from their own on-board electrolysis systems, said non-fusion spherical plasmas are being pressured into both sides of said central fusion spherical plasma as shown in FIGS. 12A and 13, the induced Larmor orbiting particle field is applying tightening pressure as said induced Larmor orbits narrow over time, as said plasmas become more energetic, said induced electric current 186, FIG. 12A, upper diagram, within said induced electric field within a conducting spherical plasma, and around said developing fusion spherical plasma, is also increasing temperature of said fusion spherical plasma, emitted electromagnetic radiation from oscillatory circuit, FIG. 5, is also increasing temperature within said fusion spherical plasma, said electromagnetic radiation on top hull of craft, is being emitted through the ball electrode on top of said pyramid shaped columnar cone, the induced magnetic fields around the annular blade rings 49a and 49b, FIG. 5, of the two larger aircraft are intermixing their fluxes with said smaller craft flux, all revolving in different directions, and also intermixing their fluxes, location of said intermixing fluxes being in large part within area of said fusion spherical plasma, raising the temperature toward the temperature required for ignition of fusion spherical (plasma) plasma, and, energetic charged particals from said induced Larmor orbiting particle field 182, FIG. 12A, upper diagram, side-view of said Larmor energetic particle field, and a top view of said Larmor energetic particle field 184, FIG. 12C, showing said Larmor energetic particles have been squeezed into said fusion spherical plasma 170, FIG. 12C, all of said Larmor orbiting particles have been added to energetic charged particles within said fusion spherical plasma, energetic charged particles within said non-fusion spherical plasmas 174 and 178, FIG. 13, rotating in different directions from each other, and both non-fusion spherical plasmas rotating in different directions than said fusion spherical plasma, best seen in FIG. 12B, have been squeezed into said fusion spherical plasma FIG. 13, the funnel shaped plasma vortices on the top hulls of both large aircraft are intersecting their energetic charged particles within said fusion spherical plasma, and again, rotating in three different directions, are increasing temperature of said fusion plasma, said magnetic flux intersecting add the additional quanta of another energy source, the two billion degree temperature required for ignition of said fusion spherical plasma, refers to electron volt temperature, repulsive magnetic north poles are opposing on said two large aircraft, with said fusion spherical plasma in the middle, said rotational direction of movement of said bottom vortices of said large aircraft are directing pressure upon said central fusion spherical plasma,
if said fusion spherical plasma does not spontaneously ignite, ignition can be accomplished by means of hi-power laser, or neutral beam, whereupon said ignition will produce, primarily, only photon energy, and negligible radiation, there is no great risk, and a super-abundance of energetic charged particles will be produced, distances represented in FIG. 15, approximate distances pertaining to outside of craft, inside of said aircraft, chosen radius of aircraft will determine distances, heat produced requires ignition to occur on roof of said ferromagnetic aircraft with high melting temperature and due to low melting temperature of said large aircraft magnesium aluminum hulls, immediate separation from said expanding fusion spherical plasma will be required after ignition FIG. 14, said expanding plasma will force said large craft on the left, aircraft B, 30 feet to the left, said large craft on the right, aircraft C, will move 100 feet rapidly to the right, said large craft are positioned perpendicular with said expanding plasma, and also perpendicular to earth, said craft on the right is drawing said expanding plasma to the right, said fusion plasma will expand to the right, said three aircraft will have grounded said craft by means of attachment or disengagement grounding devices, grounding to railroad tracks is the preferred grounding means, or grounding to correct line on hi-power tension poles, is another recommended grounding means, said fusion spherical plasma will attempt to reform in the middle of a huge blimp shaped, opaque plasma formation, said plasma cloud is located between area of ignition and over 100 feet to the right, aircraft C being at the end of said plasma to the right, aircraft B is located 30 feet to the left of ignition site, at the other end of said blimp shaped opaque plasma cloud, assuming observed operation is occuring in the early morning right before daybreak, otherwise, it might not be visible, said fusion plasma produced energetic charged particles attempt to reorganize into a sphere in center of said blimp shaped plasma, but collapse due to loss of organizing energy, said charged particles produced by said fusion reaction having been absorbed into said aircraft funnel-shaped plasma vortices, what remains is essentially a cloud of electrostatic, essentially remnant ions, similar to a raincloud, said plasma cloud collapses, a bolt of green, positive electricity goes to the extended rod on the top of aircraft B,
a bolt of blue, red, white (moving) electricity goes to an extended rod on the bottom of aircraft C, said small aircraft, aircraft A, departed ignition site immediately after ignition, disengaging from grounding to said hi-tension power line,
said produced charged particles, moving electricity, can be beamed to a power storage area, stored in said aircraft plasma vortices 34, 34′ and 34a, 34a′, FIG. 1, or stored in said aircraft capacitance inductance systems.

18. (canceled)

19. (canceled)

20. (canceled)

21. The method of claim 17, wherein a method for forming a fusion spherical plasma within an oscillatory, inhomogeneous plasma, will comprise the steps of:
a) utilizing said glass ball electrode 169, FIG. 11B, on roof of said smaller aircraft, and also utilize said glass ball electrodes present on roofs of said larger magnesium aluminum hulled craft.
b) utilizing the fuels boron B-11 isotope ion and H-1 atoms.
c) electrolyzing said H-1 fuels out of water within said aircraft, and vaporizing previously said boron B-11 isotope ion out of source or electrolyzing seawater, and vaporizing said boron B-11 isotope ion out of seawater source on-board said aircraft.
d) placing said electrolyzed elements within necessary gyro orbits on roof of said aircraft by means of said ferromagnetic cored columns within said aircraft, FIGS. 11A and 12E.
whereby, said smaller induced magnetic, electric and Larmor gyro orbiting particle fields, will be formed around under said raised ball electrode, and around said raised pyramid shaped columnar cone topped with said ball electrode, rapidly forming a developed fusion spherical plasma.

22. A method for obtaining ignition of said formed fusion spherical plasma on roof of said smaller aircraft, will comprise the steps of:
a) utilizing said two larger aircraft with said non-fusion spherical plasmas on roofs of said larger aircraft, and positioning said spherical plasmas of said larger aircraft on each side of said central fusion spherical plasma on roof of said smaller aircraft, FIG. 12A, upper diagram, and applying rotational pressure from bottom rotating vortices of said larger aircraft FIG. 12A, toward said central fusion spherical plasma 170, FIG. 12A, upper diagram, and grounding said aircraft to the ground.
whereby, said induced Larmor gyro orbiting particle field, and said spherical plasmas on roofs of said larger aircraft, and roof of said central fusion spherical plasma, all of said systems containing energetic charged particles, will be pressured into a single amorphous mass FIG. 13, forminig said (final) fusion spherical plasma for spontaneous ignition, or ignition by said hi-power laser or neutral beam, FIG. 14.

23. A method for containing said fusion nuclear reaction after ignition FIG. 14, will comprise the steps of:
a) moving said perpendicular large craft B FIG. 14 to the left 30 feet FIG. 15,
b) moving said perpendicular large craft C FIG. 14 to the right approximately 100 feet FIG. 15, after ignition of said fusion spherical plasma FIG. 14,
whereby, a single large, contained plasma, approximately 130 feet in width, will be formed between the plasma vortices of said two or more large aircraft FIG. 15, and all of said energetic charged particles, moving electricity, produced by said aircraft top and bottom plasma vortices 34, 34′ and 34a, 34a′, FIG. 1, and within aircraft oscillatory circuit FIG. 5, or beamed by microwave to a storage location.
